(19) United States
(12) Patent Application Publication
(10) Pub. No.: US 2023/0362981 A1
(43) Pub. Date: Nov. 9, 2023

(54) SIGNALING FOR CHANNEL ACCESS USING MULTI-BEAM SENSING

(71) Applicant: QUALCOMM Incorporated, San Diego, CA (US)

(72) Inventors: Vinay CHANDE, San Diego, CA (US); Jing SUN, San Diego, CA (US)

(21) Appl. No.: 18/312,299

(22) Filed: May 4, 2023

Related U.S. Application Data
(60) Provisional application No. 63/339,329, filed on May 6, 2022.

(51) Int. Cl. H04W 74/00

(52) U.S. Cl. CPC H04W 74/002

(57) ABSTRACT

Methods, systems, and devices for wireless communications are described. Some wireless communications systems may support signaling for channel access using multi-beam sensing. In some cases, a user equipment (UE) may transmit a capability message indicating a capability of the UE to support per-beam channel access procedures for communicating in one or more shared radio frequency spectrum. In some cases, the UE may receive, from a network entity, a control message indicating a channel occupancy configuration that is associated with the per-beam channel access procedures. Additionally, the UE may perform a per-beam channel access procedure for each beam of a set of beams and may communicate via one or more beams from the set of beams based on the channel occupancy configuration and the per-beam channel access procedures being successful for at least a subset of beams of the set of beams.

### CROSS REFERENCE

The present application for patent claims the benefit of U.S. Provisional Patent Application No. 63/339,329 by CHANDE et al., entitled “SIGNALING FOR CHANNEL ACCESS USING MULTI-BEAM SENSING,” filed May 6, 2022, assigned to the assignee hereof, and expressly incorporated by reference herein.

### FIELD OF TECHNOLOGY

The following relates to wireless communications, including signaling for channel access using multi-beam sensing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support signaling for channel access using multi-beam sensing. Generally, the techniques described herein may enable a user equipment (UE) to transmit an indication of a capability of the UE to support per-beam channel access procedures. Additionally, or alternatively, the described techniques may enable the UE to receive an indication of a channel occupancy configuration associated with the per-beam channel access procedure. For example, a UE may transmit a capability message indicating a capability of the UE to support per-beam channel access procedures for communicating in one or more shared (e.g., unlicensed) radio frequency spectrum bands. The capability message may include an indication of a threshold (e.g., a maximum) quantity of simultaneous per-beam channel access procedures supported by the UE. Additionally, or alternatively, the UE may receive a control message indicating a channel occupancy configuration associated with the per-beam channel access procedures. In such cases, the channel occupancy configuration may enable or disable the ability of the UE to communicate on a channel during a channel occupancy time (COT) when only a subset of beams from a set of beams are associated with successful per-beam channel access procedures. In some cases, the UE may perform a per-beam channel access procedure on each beam from the set of beams (e.g., according to the capability of the UE) and may communicate via one or more beams based on the channel occupancy configuration and the per-beam channel access procedures being successful on at least the subset of beams.

A method for wireless communications at a UE is described. The method may include receiving a control message indicating a channel occupancy configuration that is associated with per-beam channel access procedures for communicating in one or more shared radio frequency spectrum bands, performing a per-beam channel access procedure for each beam of a set of multiple beams, and communicating via one or more beams from the set of multiple beams based on the channel occupancy configuration and the per-beam channel access procedures being successful for at least a subset of beams of the set of multiple beams.

An apparatus for wireless communications at a UE is described. The apparatus may include a processor, memory coupled with the processor, and instructions stored in the memory. The instructions may be executable by the processor to cause the apparatus to receive a control message indicating a channel occupancy configuration that is associated with per-beam channel access procedures for communicating in one or more shared radio frequency spectrum bands, perform a per-beam channel access procedure for each beam of a set of multiple beams, and communicate via one or more beams from the set of multiple beams based on the channel occupancy configuration and the per-beam channel access procedures being successful for at least a subset of beams of the set of multiple beams.

Another apparatus for wireless communications at a UE is described. The apparatus may include means for receiving a control message indicating a channel occupancy configuration that is associated with per-beam channel access procedures for communicating in one or more shared radio frequency spectrum bands, means for performing a per-beam channel access procedure for each beam of a set of multiple beams, and means for communicating via one or more beams from the set of multiple beams based on the channel occupancy configuration and the per-beam channel access procedures being successful for at least a subset of beams of the set of multiple beams.

A non-transitory computer-readable medium storing code for wireless communications at a UE is described. The code may include instructions executable by a processor to receive a control message indicating a channel occupancy configuration that is associated with per-beam channel access procedures for communicating in one or more shared radio frequency spectrum bands, perform a per-beam channel access procedure for each beam of a set of multiple beams, and communicate via one or more beams from the set of multiple beams based on the channel occupancy configuration and the per-beam channel access procedures being successful for at least a subset of beams of the set of multiple beams.

In some examples of the method, apparatuses, and non-transitory computer-readable medium described herein, communicating via the one or more beams may include operations, features, means, or instructions for communicating on a channel during a COT based on the per-beam channel access procedures being successful for the subset of beams, the one or more beams including the subset of beams.

In some examples of the method, apparatuses, and non-transitory computer-readable medium described herein, the channel occupancy configuration enables use of the COT by the UE when only the subset of beams may have a successful per-beam channel access procedure.

In some examples of the method, apparatuses, and non-transitory computer-readable medium described herein, communicating via the one or more beams may include operations, features, means, or instructions for communicating on a channel during a COT based on the per-beam channel access procedures being successful for every beam of the set of multiple beams, the one or more beams including the set of multiple beams.

In some examples of the method, apparatuses, and non-transitory computer-readable medium described herein, the channel occupancy configuration disables use of the COT by the UE when only the subset of beams may have a successful per-beam channel access procedure.

In some examples of the method, apparatuses, and non-transitory computer-readable medium described herein, performing the per-beam channel access procedure may include operations, features, means, or instructions for performing the per-beam channel access procedure for each beam of the set of multiple beams based on one or more timers associated with the per-beam channel access procedure, where the UE determines that the per-beam channel access procedures may be successful upon expiration of the one or more timers.

In some examples of the method, apparatuses, and non-transitory computer-readable medium described herein, the control message includes an indication of the one or more timers associated with the per-beam channel access procedure.

In some examples of the method, apparatuses, and non-transitory computer-readable medium described herein, receiving the control message may include operations, features, means, or instructions for receiving a radio resource control message indicating the channel occupancy configuration, the channel occupancy configuration including a UE-specific configuration for the UE.

In some examples of the method, apparatuses, and non-transitory computer-readable medium described herein, receiving the control message may include operations, features, means, or instructions for receiving a system information message indicating the channel occupancy configuration, the channel occupancy configuration including a cell-specific configuration for a cell provided by a network entity.

In some examples of the method, apparatuses, and non-transitory computer-readable medium described herein, the channel occupancy configuration may be based on a traffic type, one or more other wireless devices communicating with the UE, a number of wireless devices in a same cell as the UE, or any combination thereof.

In some examples of the method, apparatuses, and non-transitory computer-readable medium described herein, the channel occupancy configuration may be based on a radio access technology (RAT) used by one or more network entities or wireless devices for communicating in the one or more shared radio frequency spectrum bands.

Some examples of the method, apparatuses, and non-transitory computer-readable medium described herein may further include operations, features, means, or instructions for transmitting a capability message indicating a capability of the UE to support the per-beam channel access procedure, where receiving the control message may be based on the capability message.

A method for wireless communications at a UE is described. The method may include transmitting a capability message indicating a capability of the UE to support per-beam channel access procedures for communicating in one or more shared radio frequency spectrum bands, performing a per-beam channel access procedure for one or more beams of a set of multiple beams in accordance with the capability, and communicating via the one or more beams based on the per-beam channel access procedures being successful.

An apparatus for wireless communications at a UE is described. The apparatus may include a processor, memory coupled with the processor, and instructions stored in the memory. The instructions may be executable by the processor to cause the apparatus to transmit a capability message indicating a capability of the UE to support per-beam channel access procedures for communicating in one or more shared radio frequency spectrum bands, perform a per-beam channel access procedure for one or more beams of a set of multiple beams in accordance with the capability, and communicate via the one or more beams based on the per-beam channel access procedures being successful.

Another apparatus for wireless communications at a UE is described. The apparatus may include means for transmitting a capability message indicating a capability of the UE to support per-beam channel access procedures for communicating in one or more shared radio frequency spectrum bands, means for performing a per-beam channel access procedure for one or more beams of a set of multiple beams in accordance with the capability, and means for communicating via the one or more beams based on the per-beam channel access procedures being successful.

A non-transitory computer-readable medium storing code for wireless communications at a UE is described. The code may include instructions executable by a processor to transmit a capability message indicating a capability of the UE to support per-beam channel access procedures for communicating in one or more shared radio frequency spectrum bands, perform a per-beam channel access procedure for one or more beams of a set of multiple beams in accordance with the capability, and communicate via the one or more beams based on the per-beam channel access procedures being successful.

In some examples of the method, apparatuses, and non-transitory computer-readable medium described herein, transmitting the capability message may include operations, features, means, or instructions for transmitting, within the capability message, an indication of a threshold quantity of simultaneous per-beam channel access procedures supported by the UE.

In some examples of the method, apparatuses, and non-transitory computer-readable medium described herein, the indication includes a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

Some examples of the method, apparatuses, and non-transitory computer-readable medium described herein may further include operations, features, means, or instructions for receiving a control message indicating a channel occupancy configuration that may be associated with the per-beam channel access procedures.

In some examples of the method, apparatuses, and non-transitory computer-readable medium described herein, the per-beam channel access procedures may be successful for a subset of beams of the set of multiple beams and the subset of beams may be used for communicating during a COT based on the channel occupancy configuration enabling use of the COT by the UE when only the subset of beams may have a successful per-beam channel access procedure.

In some examples of the method, apparatuses, and non-transitory computer-readable medium described herein, the per-beam channel access procedures may be successful for every beam of the set of multiple beams and the set of multiple beams may be used for communicating during a COT based on the channel occupancy configuration disabling use of the COT by the UE when only a subset of beams from the set of multiple beams may have a successful per-beam channel access procedure.

A method for wireless communications at a network entity is described. The method may include transmitting a control message indicating a channel occupancy configuration that is associated with per-beam channel access procedures for communicating in one or more shared radio frequency spectrum bands and communicating with a UE via one or more beams from a set of multiple beams based on the channel occupancy configuration.

An apparatus for wireless communications at a network entity is described. The apparatus may include a processor, memory coupled with the processor, and instructions stored in the memory. The instructions may be executable by the processor to cause the apparatus to transmit a control message indicating a channel occupancy configuration that is associated with per-beam channel access procedures for communicating in one or more shared radio frequency spectrum bands and communicate with a UE via one or more beams from a set of multiple beams based on the channel occupancy configuration.

Another apparatus for wireless communications at a network entity is described. The apparatus may include means for transmitting a control message indicating a channel occupancy configuration that is associated with per-beam channel access procedures for communicating in one or more shared radio frequency spectrum bands and means for communicating with a UE via one or more beams from a set of multiple beams based on the channel occupancy configuration.

A non-transitory computer-readable medium storing code for wireless communications at a network entity is described. The code may include instructions executable by a processor to transmit a control message indicating a channel occupancy configuration that is associated with per-beam channel access procedures for communicating in one or more shared radio frequency spectrum bands and communicate with a UE via one or more beams from a set of multiple beams based on the channel occupancy configuration.

In some examples of the method, apparatuses, and non-transitory computer-readable medium described herein, communicating via the one or more beams may include operations, features, means, or instructions for communicating on a channel during a COT based on the channel occupancy configuration, the one or more beams including a subset of beams from the set of multiple beams.

In some examples of the method, apparatuses, and non-transitory computer-readable medium described herein, the channel occupancy configuration enables use of the COT by a UE when only the subset of beams may have a successful per-beam channel access procedure.

In some examples of the method, apparatuses, and non-transitory computer-readable medium described herein, communicating via the one or more beams may include operations, features, means, or instructions for communicating on a channel during a COT based on the channel occupancy configuration, the one or more beams including the set of multiple beams.

In some examples of the method, apparatuses, and non-transitory computer-readable medium described herein, the channel occupancy configuration disables use of the COT by a UE when only a subset of beams may have a successful per-beam channel access procedure.

In some examples of the method, apparatuses, and non-transitory computer-readable medium described herein, transmitting the control message may include operations, features, means, or instructions for transmitting an indication of one or more timers associated with the per-beam channel access procedure, where the control message includes the indication.

In some examples of the method, apparatuses, and non-transitory computer-readable medium described herein, transmitting the control message may include operations, features, means, or instructions for transmitting a radio resource control message indicating the channel occupancy configuration, the channel occupancy configuration including a UE-specific configuration for the UE.

In some examples of the method, apparatuses, and non-transitory computer-readable medium described herein, transmitting the control message may include operations, features, means, or instructions for transmitting a system information message indicating the channel occupancy configuration, the channel occupancy configuration including a cell-specific configuration for a cell provided by the network entity.

Some examples of the method, apparatuses, and non-transitory computer-readable medium described herein may further include operations, features, means, or instructions for identifying a presence of one or more other network entities or wireless devices communicating in the one or more shared radio frequency spectrum bands, where the channel occupancy configuration may be based on a RAT used by each of the one or more other network entities or wireless devices.

In some examples of the method, apparatuses, and non-transitory computer-readable medium described herein, the channel occupancy configuration may be based on a traffic type, one or more other wireless devices communicating with a UE, a number of wireless devices in a same cell as the UE, or any combination thereof.

Some examples of the method, apparatuses, and non-transitory computer-readable medium described herein may further include operations, features, means, or instructions for receiving a capability message indicating a capability of a UE to support the per-beam channel access procedure, where receiving the control message may be based on the capability message.

A method for wireless communications at a network entity is described. The method may include receiving a capability message indicating a capability of a UE to support per-beam channel access procedures for communicating in one or more shared radio frequency spectrum bands and communicating with the UE via one or more beams from a set of multiple beams based on the capability.

An apparatus for wireless communications at a network entity is described. The apparatus may include a processor, memory coupled with the processor, and instructions stored in the memory. The instructions may be executable by the processor to cause the apparatus to receive a capability message indicating a capability of a UE to support per-beam channel access procedures for communicating in one or more shared radio frequency spectrum bands and communicate with the UE via one or more beams from a set of multiple beams based on the capability.

Another apparatus for wireless communications at a network entity is described. The apparatus may include means for receiving a capability message indicating a capability of a UE to support per-beam channel access procedures for communicating in one or more shared radio frequency spectrum bands and means for communicating with the UE via one or more beams from a set of multiple beams based on the capability.

A non-transitory computer-readable medium storing code for wireless communications at a network entity is described. The code may include instructions executable by a processor to receive a capability message indicating a capability of a UE to support per-beam channel access procedures for communicating in one or more shared radio frequency spectrum bands and communicate with the UE via one or more beams from a set of multiple beams based on the capability.

In some examples of the method, apparatuses, and non-transitory computer-readable medium described herein, receiving the capability message may include operations, features, means, or instructions for receiving, within the capability message, an indication of a threshold quantity of simultaneous per-beam channel access procedures supported by the UE.

In some examples of the method, apparatuses, and non-transitory computer-readable medium described herein, the indication includes a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

Some examples of the method, apparatuses, and non-transitory computer-readable medium described herein may further include operations, features, means, or instructions for transmitting a control message indicating a channel occupancy configuration that may be associated with the per-beam channel access procedures.

In some examples of the method, apparatuses, and non-transitory computer-readable medium described herein, a subset of beams of the set of multiple beams may be used for communicating during a COT based on the channel occupancy configuration enabling use of the COT by the UE when only the subset of beams may have a successful per-beam channel access procedure.

In some examples of the method, apparatuses, and non-transitory computer-readable medium described herein, the set of multiple beams may be used for communicating during a COT based on the channel occupancy configuration disabling use of the COT by the UE when only a subset of beams from the set of multiple beams may have a successful per-beam channel access procedure.

In some examples of the method, apparatuses, and non-transitory computer-readable medium described herein, the channel occupancy configuration may be based on a RAT used by one or more network entities or wireless devices for communicating in the one or more shared radio frequency spectrum bands.

Some examples of the method, apparatuses, and non-transitory computer-readable medium described herein may further include operations, features, means, or instructions for identifying a presence of one or more other network entities or wireless devices communicating in the one or more shared radio frequency spectrum bands, where the channel occupancy configuration may be based on a RAT used by each of the one or more other network entities or wireless devices.

### BRIEF DESCRIPTION OF THE DRAWINGS

FIG. 1 illustrates an example of a wireless communications system that supports signaling for channel access using multi-beam sensing in accordance with one or more aspects of the present disclosure.

FIGS. 2A, 2B, and 3 illustrate examples of channel access procedures that support signaling for channel access using multi-beam sensing in accordance with one or more aspects of the present disclosure.

FIG. 4 illustrates an example of a process flow in a system that supports signaling for channel access using multi-beam sensing in accordance with one or more aspects of the present disclosure.

FIGS. 5 and 6 show block diagrams of devices that support signaling for channel access using multi-beam sensing in accordance with one or more aspects of the present disclosure.

FIG. 7 shows a block diagram of a communications manager that supports signaling for channel access using multi-beam sensing in accordance with one or more aspects of the present disclosure.

FIG. 8 shows a diagram of a system including a device that supports signaling for channel access using multi-beam sensing in accordance with one or more aspects of the present disclosure.

FIGS. 9 and 10 show block diagrams of devices that support signaling for channel access using multi-beam sensing in accordance with one or more aspects of the present disclosure.

FIG. 11 shows a block diagram of a communications manager that supports signaling for channel access using multi-beam sensing in accordance with one or more aspects of the present disclosure.

FIG. 12 shows a diagram of a system including a device that supports signaling for channel access using multi-beam sensing in accordance with one or more aspects of the present disclosure.

FIGS. 13 through 16 show flowcharts illustrating methods that support signaling for channel access using multi-beam sensing in accordance with one or more aspects of the present disclosure.

### DETAILED DESCRIPTION

Some wireless communications systems may support channel access procedures, such as listen-before-talk (LBT) procedures or other channel sensing procedures. For example, a wireless device (e.g., a user equipment (UE), a network entity) may perform an LBT procedure to identify the presence of other signals on a channel in a shared radio frequency spectrum band (e.g., an unlicensed band) to determine whether the wireless device may communicate on the channel (e.g., to determine whether the channel is busy or not). Additionally, some wireless communications systems may support per-beam channel access procedures, such as per-beam LBT procedures. For example, a wireless device may perform independent per-beam sensing of each beam of a set of two or more beams to be used during a channel occupancy time (COT). In some cases, the wireless device may perform independent per-beam LBT procedures on each beam of the set of beams simultaneously, such that the success of failure of a per-beam LBT procedure on a first beam of the set of beams may not be dependent on the success or failure of a per-beam LBT procedure on a second beam of the set of beams.

In some cases, the per-beam LBT procedures may be successful for a subset of beams of the set of beams. In such cases, the wireless device may determine whether to communicate on the channel during a COT via the subset of beams associated with the successful per-beam channel access procedures. In other examples, the wireless device may determine to refrain from communicating on the channel during the COT until the per-beam channel access procedures is successful for every beam of the set of beams (e.g., until the wireless device can communicate on the channel via the full set of beams). In some cases, however, a network entity may be unaware of the determination made by the UE, which may result in communication inefficiencies.

Techniques described herein may support signaling for channel access using multi-beam sensing. For example, a UE may transmit, to a network entity, an indication of a capability of the UE to support per-beam channel access procedures (e.g., per-beam LBT procedures). The capability message may include an indication of a threshold (e.g., maximum) quantity of simultaneous per-beam channel access procedures supported by the UE. In such cases, the UE may perform per-beam sensing procedures (e.g., LBT procedures) for each beam of a set of beams to determine if any beams (and corresponding resources) are available for communications with another device (e.g., another UE, a network entity).

Additionally, or alternatively, the UE may receive an indication of a channel occupancy configuration (e.g., Subset-BeamsCOT) associated with the per-beam channel access procedures. The channel occupancy configuration may enable or disable the ability of the UE to communicate on a channel during a COT via a subset of beams from a set of two or more beams when only the subset of beams have successful per-beam channel access procedures. For example, the UE may perform a per-beam channel access procedure on each beam from the set of two or more beams (e.g., in accordance with the capability of the UE), and the per-beam channel access procedures may be successful on a subset of beams of the set of beams. In some cases, the UE may communicate on a channel during a COT via the subset of beams (e.g., the beams having a successful channel access procedure) based on the channel occupancy configuration enabling use of the COT when the per-beam channel access procedure is successful for the subset of beams. In some other causes, the UE may refrain from communicating on the channel until the per-beam channel access procedures are successful for every beam of the set of beams based on the channel occupancy configuration disabling use of the COT when the per-beam channel access procedure is successful for the subset of beams.

Aspects of the disclosure are initially described in the context of wireless communications systems. Aspects of the disclose are then described in the context of channel access procedures and a process flow. Aspects of the disclosure are further illustrated by and described with reference to apparatus diagrams, system diagrams, and flowcharts that relate to signaling for channel access using multi-beam sensing.

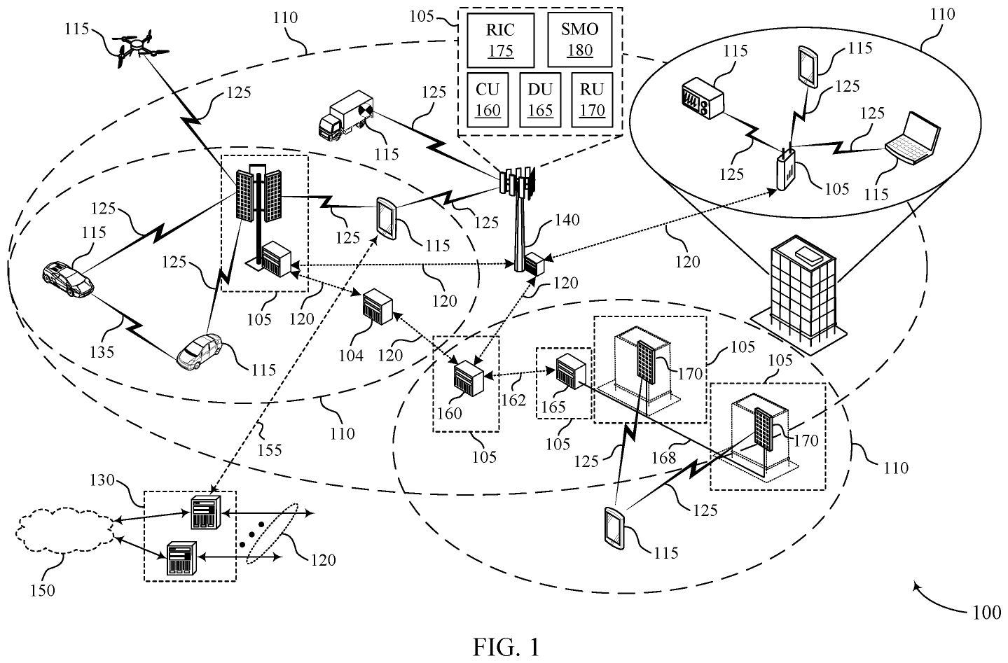

FIG. 1 illustrates an example of a wireless communications system 100 that supports signaling for channel access using multi-beam sensing in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support signaling for channel access using multi-beam sensing as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNB s or gNB s, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support signaling for channel access using multi-beam sensing. For example, a UE 115 may transmit, to a network entity 105, a capability message indicating a capability of the UE 115 to support per-beam channel access procedures, such as per-beam LBT procedures, for communicating on a shared channel (e.g., in one or more shared radio frequency spectrum bands). Additionally, or alternatively, the UE 115 may receive a control message indicating a channel occupancy configuration associated with the per-beam channel access procedures. The UE 115 may perform a per-beam channel access procedure for each beam of a set of beams (e.g., based on the capability of the UE 115) and the per-beam channel access procedures may be successful on a subset of beams of the set of beams. In some cases, the UE 115 may communicate on a channel during a COT via the subset of beams based on the channel occupancy configuration enabling use of the COT by the UE 115 when only the subset of beams have successful per-beam channel access procedures.

In some other cases, the UE 115 may refrain from communicating on the channel during the COT via the subset of beams based on the channel occupancy configuration disabling use of the COT by the UE 115 when only the subset of beams have successful per-beam channel access procedures. In such cases, the UE 115 may continue to perform per-beam LBT procedures on remaining beams of the set of beams until the per-beam channel access procedures are successful for every beam of the set of beams (e.g., the subset of beams and the remaining beams). Additionally, the UE 115 may communicate on the channel during the COT based on the per-beam channel access procedures being successful for every beam of the set of beams.

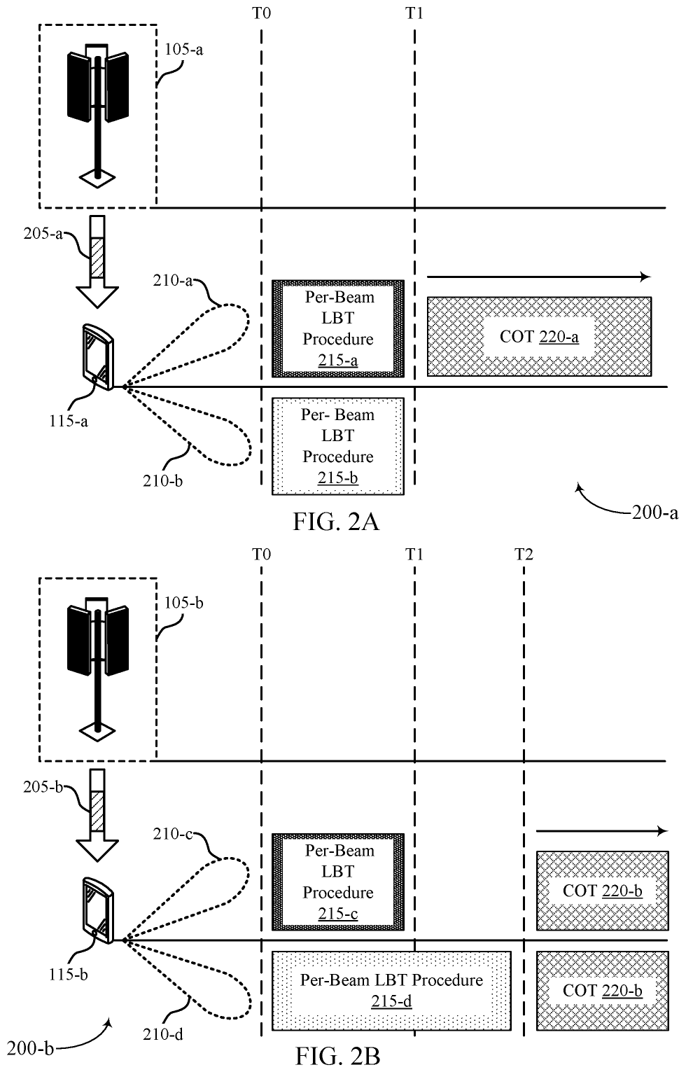

FIGS. 2A and 2B illustrate examples of channel access procedures 200, including a channel access procedure 200-a and a channel access procedure 200-b, that support signaling for channel access using multi-beam sensing in accordance with one or more aspects of the present disclosure. In some examples, the channel access procedures 200 may implement aspects of the wireless communications system 100. For example, the channel access procedures 200 may include one or more network entities 105 (e.g., a network entity 105-a and a network entity 105-b) and one or more UEs 115 (e.g., a UE 115-a and a UE 115-b), which may be examples of the corresponding devices as described with reference to FIG. 1. In the example of FIGS. 2A and 2B, the network entities 105 may be examples of a CU 160, a DU 165, an RU 170, a base station 140, an IAB node 104, or one or more other network nodes as described with reference to FIG. 1. In some cases, a network entity 105 may transmit, to a UE 115, a control message 205 indicating a channel occupancy configuration associated with per-beam channel access procedures, such as per-beam LBT procedures 215 (e.g., per-beam channel access procedures).

Some wireless communications systems may support channel access procedures, such as LBT procedures (e.g., single LBT procedures). For example, a UE 115 may monitor (e.g., perform channel sensing on) a shared communication channel (e.g., an unlicensed channel), which may be referred to herein as a channel, by performing an LBT procedure to identify the presence of other signals on the channel (e.g., to determine whether the channel is busy or not). In some cases, the UE 115 may identify the presence of other signals on the channel (e.g., transmitted by other devices) and may be unable to access the channel based on the channel being busy (e.g., based on the presence of the other signals), which may be referred to an unsuccessful LBT procedure (e.g., channel access procedure failure). In some other cases, the UE 115 may identify an absence of other signals on the channel, which may be based on one or more signal strength thresholds) and may be able to access the channel based on the channel being free (e.g., based on no other signals on the channel, based on detected signals satisfying a threshold), which may be referred to as a successful LBT procedure (e.g., channel access procedure success). In such cases, the UE 115 may communicate on the channel during a COT based on the successful LBT procedure.

A COT may refer to an amount of time for which a wireless device (e.g., a UE 115, a network entity 105), and any other wireless devices sharing channel occupancy, perform transmission(s) on a channel after a wireless device performs one or more corresponding channel access procedures. In some examples, if a transmission gap is less than or equal to some duration (e.g., 25 μs), the gap duration may be counted in the COT. A COT may be shared for transmission between a network entity 105 and one or more corresponding UEs 115. The COT may include multiple slots, where each slot includes downlink resources, uplink resources, or flexible resources, and the respective resources may be associated with one or more beams (e.g., which may be associated with TDM). In some cases, the COT may be associated with MU-MIMO transmission (e.g., using spatial-division multiplexing (SDM)). Additionally, the UE 115 may perform the LBT procedure based on the one or more beams associated with the COT. For example, at the start of the COT, the UE 115 may initially perform an LBT procedure (e.g., a single LBT procedure) for a wide beam, where the wide beam covers each beam of the one or more beams. The frequency range of the wide beam may include (e.g., encompass) frequencies associated with the one or more beams. In some examples, the UE 115 may then perform per-beam LBT procedures for relatively narrower beams to determine whether the UE 115 is able to access the COT.

In some cases, an LBT procedure may be associated with a type, such as a Type 1 LBT procedure, a Type 2 LBT procedure, or a Type 3 LBT procedure. For example, a UE 115 operating according to Type 1 LBT procedures (e.g., Category or CAT 3 LBT) may acquire a COT of a channel when LBT procedures are required (e.g., based on a UE 115 capability) and using variable sensing and/or backoff periods. In another example, a UE 115 operating according to Type 2 LBT procedures (e.g., CAT 2 LBT) may share a COT of a channel (e.g., share uplink and downlink transmissions) at least when required (e.g., based on a separate UE 115 capability) and using a fixed sensing period. In another example, a UE 115 operating according to Type 3 LBT procedures (e.g., no LBT) may share COT of a channel without performing channel access procedures. In some aspects, an LBT procedure may be referred to as a channel access procedure. Further, other channel access procedures may be performed instead of or in addition to an LBT procedure.

Some wireless communications systems may support per-beam channel access procedures, such as per-beam LBT procedures. For example, a COT may be associated with a set of beams and the UE 115 may perform an independent per-beam LBT procedure on each beam of the set of beams simultaneously (e.g., if the UE 115 is capable of performing per-beam LBT procedures). In some cases (e.g., when the COT uses TDM beams with beam switching), the UE 115 may perform per-beam LBT procedures at the start of the COT and may perform additional LBT procedures (e.g., CAT 2 LBT) prior to beam switching.

In some cases, a UE 115 may perform per-beam LBT procedures (e.g., Type 1 or Type 2) on a set of beams and the per-beam LBT procedures may succeed on a subset of beams of the set of beams (e.g., prior to succeeding on all beams of the set of beams). In such cases, the UE 115 may determine whether to communicate on the channel during the COT (e.g., occupy the COT) via the subset of beams (e.g., LBT-Won-Subset) for which the per-beam LBT procedures were successful (e.g., and abandon per-beam LBT procedures on remaining beams of the subset of beams) or refrain from communicating on the channel during the COT until the per-beam LBT procedures are successful on every beam (e.g., All-Beam-COT) of the set of beams (e.g., occupy the channel during the COT using every beam of the set of beams).

In some cases, such as when the UE 115 communicates on the channel during the COT via the subset of beams for which the per-beam LBT procedures were successful, the UE 115 may increase the chances of occupying the COT, however, a network entity 105 may be unaware of the subset of beams on which COT is occupied. In some other cases, such as when the UE 115 refrains from communicating on the channel during the COT until the per-beam LBT procedures are successful on every beam of the set of beams, the network entity 105 may know that, upon completion of the per-beam LBT procedures, the UE 115 will either occupy every beam of the set of beams or no beams of the set of beams. However, the network entity may be unaware if the UE 115 is occupying every beam of the set of beams or no beams of the set of beams. The inability of the network entity 105 (e.g., capable of acquiring the COT on the subset of beams or the set of beams) to determine what beams, if any, the UE 115 may occupy during the COT may result in communication inefficiencies.

As such, the channel access procedures 200 may support signaling for channel access using multi-beam sensing. In the examples of FIGS. 2A and 2B, a network entity 105 (e.g., network entity 105-a, network entity 105-b) may communicate with a UE 115 (e.g., UE 115-a, UE 115-b), and the network entity 105 may transmit a control message 205 indicating a channel occupancy configuration (e.g., RRC configuration) associated with per-beam channel access procedures, such as per-beam LBT procedures 215 (e.g., per-beam LBT procedure 215-a, per-beam LBT procedure 215-b, per-beam LBT procedure 215-c, per-beam LBT procedure 215-d). The channel occupancy configuration may enable or disable the ability of the UE 115 to communicate on a channel (e.g., a shared channel in one or more shared radio frequency spectrum bands) during a COT 220 when the per-beam LBT procedures 215 are successful for a subset of beams of a set of two or more beams 210 (e.g., including beam 210-a and beam 210-b or beam 210-c and beam 210-d).

In some cases, control message 205 may be an RRC message and the channel occupancy configuration indicated in the control message 205 may be a UE-specific configuration for the UE 115. In some other cases, the control message 205 may include system information (e.g., may be a system information message), such as one or more system information blocks (SIBs), and the channel occupancy configuration indicated in the control message 205 may be a cell-specific configuration for a cell in which the UE 115 is located (e.g., provided by the network entity 105). That is, the UE 115 and other UEs 115 located in the cell may be configured with the same cell-specific configuration.

In some cases, the channel occupancy configuration may be based on a traffic type, one or more other wireless devices communicating with the UE 115, a number of wireless devices in the same cell as the UE 115, or any combination thereof. As such, the network entity 105-a or the network entity 105-b may enable or disable the ability of the UE 115 to communicate on a channel during a COT 220 (e.g., COT 220-a, COT 220-b) when the per-beam LBT procedures 215 are successful for a subset of the set of beams 210 based on a traffic type, one or more other wireless devices communicating with the UE 115, a number of wireless devices in the same cell as the UE 115, or any combination thereof. For example, the network entity 105-a may enable the ability of the UE 115 to communicate on a channel during a COT 220 when the per-beam LBT procedures 215 are successful for a subset of the set of beams 210 when a traffic type is associated with low-priority traffic, when the quantity of wireless devices communicating with the UE 115 exceeds a threshold quantity, when the number of wireless devices in the same cell as the UE 115 exceeds a threshold number, or any combination thereof. Conversely, the network entity 105-a may disable the ability of the UE 115 to communicate on a channel during COT 220 when the per-beam LBT procedures 215 are successful for a subset of beams of the set of beams 210 when a traffic type is associated with high priority traffic, when the quantity of wireless devices communicating with the UE 115 is at or below the threshold quantity, when the number of wireless devices in the same cell as the UE 115 is at or below the threshold number, or any combination thereof.

Additionally, or alternatively, the channel occupancy configuration may be based on a RAT (e.g., 5G NR, or other RAT) used by one or more network entities 105 or wireless devices for communication in one or more shared radio frequency spectrum bands in which the UE 115 is performing the per-beam LBT procedures 215 (e.g., the same shared radio frequency spectrum). For example, the network entity 105 may identify a presence of one or more other network entities 105 or wireless devices communicating in the one or more shared radio frequency spectrum bands and may enable or disable the ability of the UE 115 to communicate on a channel in the one or more shared radio frequency spectrum bands during a COT 220 when the per-beam LBT procedures 215 are successful for a subset of beams of the set of beams 210. The enabling or disabling of the ability to communicate on the channel during the COT 220 when the per-beam LBT procedures 215 are successful for a only subset of beams of the set of beams 210 may be based on whether the one or more other network entities 105 or the wireless devices are present, and may be further based on the RAT(s) used by the other network entities 105 or wireless devices.

In the example of FIG. 2A, the network entity 105-a may transmit, to the UE 115-a, a control message 205-a indicating a channel occupancy configuration that enables use of a COT 220 by the UE 115-a when only a subset of beams 210 have a successful per-beam LBT procedure 215. For example, the UE 115-a may identify a channel that the UE 115-a may use (e.g., would like to use) to communicate with the network entity 105-a during a COT 220-a. The COT 220-a may include resources associated with one or more beams 210, including a beam 210-a and a beam 210-b. As such, at time T0, the UE 115-a may initiate (e.g., perform) a per-beam LBT procedure 215-a on the beam 210-a and a per-beam LBT procedure 215-b on the beam 210-b (e.g., simultaneously). In some cases, at time T1, the per-beam LBT procedure 215-a on the beam 210-a may be successful while the per-beam LBT procedure 215-b on the beam 210-b may be unsuccessful. In such cases, the UE 115-a may communicate on the channel during the COT 220-a via the beam 210-a based on the per-beam LBT procedure 215-a being successful and the channel occupancy configuration enabling use of the COT 220-a by the UE 115-a when only a subset of the set of beams 210, such as the beam 210-a, have a successful per-beam LBT procedure 215, such as the per-beam LBT procedure 215-a. Additionally, the UE 115-a may abandon the per-beam LBT procedure 215-b on the beam 210-b (e.g., at time T1). That is, the UE 115-a may refrain from communicating on the channel during the COT 220-a via the beam 210-b. In other words, the UE 115-a may occupy the beam 210-a in the COT 220-a and refrain from occupying the beam 210-b in the COT 220-a.

In some cases, the UE 115-a may perform the per-beam LBT procedures 215 according to a timer, which may be transmitted in a control message 205. For example, the network entity 105-a may transmit an indication of the timer in the control message 205-a, such that time T1 corresponds to expiration of the timer. That is, the UE 115-a may initiate the per-beam LBT procedures 215 at time TO and, upon expiration of the timer at time T1, the UE 115-a may determine success or failure of each of the per-beam LBT procedures 215. In some cases, the timer may be associated with a time duration, such that an expiration of the timer corresponds to some time duration (e.g., of performing the per-beam LBT procedures 215), which may exceed a threshold time duration associated with the timer. In some other cases, the timer may be a counter, such that expiration of the counter corresponds to a value of the counter exceeding a threshold value. For example, at time T0, the UE 115-a may initiate the per-beam LBT procedures 215 and start counting (e.g., start the counter) for a quantity of slots (e.g., NR slots or mini-slots) or symbols (e.g., OFDM symbols). Additionally, the UE 115-a may determine success or failure of the per-beam LBT procedures 215 based on a counted quantity of slots or symbols exceeding a threshold quantity (e.g., at time T1).

In the example of FIG. 2B, the network entity 105-b may transmit, to the UE 115-b, a control message 205-b indicating a channel occupancy configuration that disables use of a COT 220 by the UE 115-b when only a subset of beams 210 have a successful per-beam LBT procedure 215. For example, the UE 115-b may identify a channel that the UE 115-b may use (e.g., would like to use) to communicate with the network entity 105-b during a COT 220-b. The COT 220-b may include resources associated with one or more beams 210, including a beam 210-c and a beam 210-d. As such, at time T0, the UE 115-b may initiate (e.g., perform) a per-beam LBT procedure 215-c on the beam 210-c and a per-beam LBT procedure 215-d on the beam 210-d (e.g., simultaneously). In some cases, at time T1, the per-beam LBT procedure 215-c on the beam 210-c may be successful while the per-beam LBT procedure 215-d on the beam 210-d may be unsuccessful. In such cases, the UE 115-b may continue to perform the per-beam LBT procedure 215-d on the beam 210-d until the per-beam LBT procedure 215-d is successful, at time T2, based on the channel occupancy configuration disabling use of the COT 220-b by the UE 115-b when only a subset of beams 210 have a successful per-beam LBT procedure 215. As such, at time T2, the per-beam LBT procedure 215-c and the per-beam LBT procedure 215-d may be successful such that the UE 115-b may communicate on the channel during the COT 220-b via the beam 210-c and the beam 210-d. That is, the UE 115-b may occupy the beam 210-c and the beam 210-d in the COT 220-b.

While much of the present disclosure is described in the context of per-beam LBT procedures, this is not to be regarded as a limitation of the present disclosure. Indeed, it is contemplated herein that a channel occupancy configuration may be associated with per-beam channel access procedures, including per-beam LBT procedures. In this regard, other per-beam channel access procedures may be considered with regards to the techniques described herein.

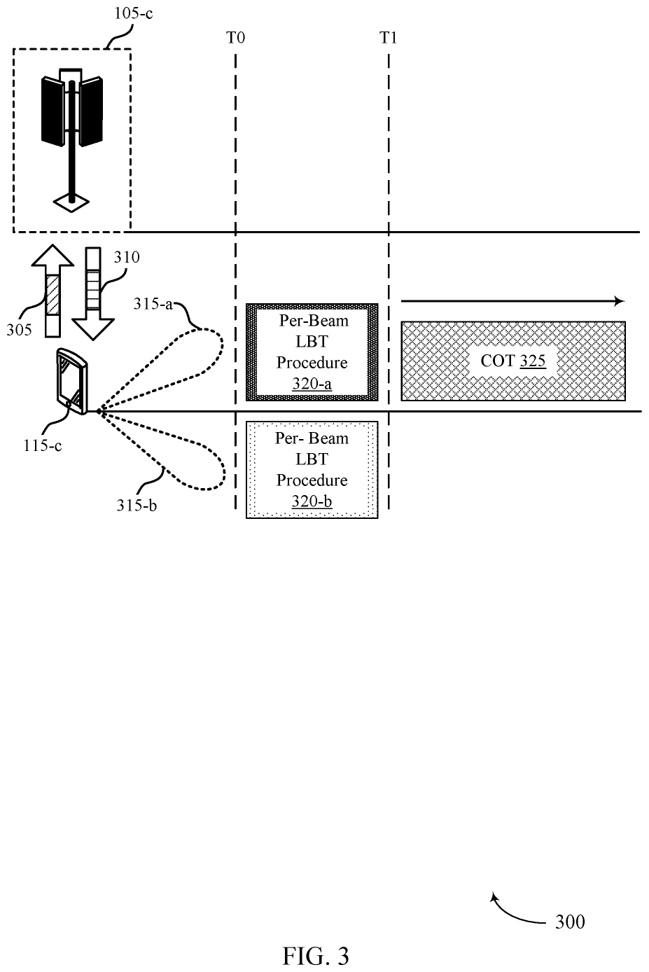

FIG. 3 illustrates an example of a channel access procedure 300 that supports signaling for channel access using multi-beam sensing in accordance with one or more aspects of the present disclosure. In some examples, the channel access procedures 300 may implement aspects of the wireless communications system 100 and the channel access procedures 200. For example, the channel access procedures 300 may include one or more network entities 105 (e.g., a network entity 105-c) and one or more UEs 115 (e.g., a UE 115-c), which may be examples of the corresponding devices as described with reference to FIGS. 1-2. In the example of FIG. 3, the network entities 105 may be examples of a CU 160, a DU 165, an RU 170, a base station 140, an IAB node 104, or one or more other network nodes as described with reference to FIG. 1. In some cases, the network entity UE 115-c may transmit, to the network entity 105-c, a capability message 305 indicating a capability of the UE 115-c to support per-beam channel access procedures, such as per-beam LBT procedures 320 (e.g., per-beam LBT procedure 320-a, per-beam LBT procedure 320-b).

As described herein, the UE 115-c may transmit, to the network entity 105-c, the capability message 305 indicating a capability of the UE 115-c to support per-beam LBT procedures 320 (e.g., channel access procedures). In some cases, the capability message 305 may include an indication of a threshold quantity (e.g., maximum quantity) of simultaneous per-beam LBT procedures 320 supported by the UE 115-c. In some cases, the threshold quantity may be based on a type of per-beam LBT procedure 320. For example, the per-beam LBT procedures 320 may be associated with a first type (e.g., Type 1), a second type (e.g., Type 2), or a third type (e.g., Type 3). As such, the indication in the capability message 305 may include a threshold quantity of simultaneous per-beam LBT procedures 320 associated with a first type, a threshold quantity of simultaneous per-beam LBT procedures 320 associated with a second type, a threshold quantity of simultaneous per-beam LBT procedures 320 associated with a third type, or any combination thereof.

In some cases, the capability message 305 may indicate that the UE 115-c is capable of supporting the per-beam LBT procedures 320. Additionally, the network entity 105-c may transmit a control message 310 indicating a channel occupancy configuration (e.g., RRC configuration) associated with per-beam channel access procedures, such as the per-beam LBT procedures 320. That is, the channel occupancy configuration may enable or disable the ability of the UE 115-c to communicate on a channel (e.g., a shared channel in one or more shared radio frequency spectrum bands) during a COT 325 when the per-beam LBT procedures 320 are successful for a subset of beams of a set of two or more beams 315 (e.g., including beam 315-a and beam 315-b), as described with reference to FIGS. 2A and 2B.

In the example of FIG. 3, the network entity 105-c may transmit the control message 310 indicating a channel occupancy configuration that enables use of the COT 325 by the UE 115-c when only a subset of beams 315 have a successful per-beam LBT procedure 320, as described with reference to FIG. 2A. For example, the UE 115-c may identify a channel that the UE 115-c may use (e.g., would like to use) to communicate with the network entity 105-c during the COT 325. The COT 325 may include resources associated with one or more beams 315, including a beam 315-a and a beam 315-b. As such, at time T0, the UE 115-c may initiate (e.g., perform) a per-beam LBT procedure 320-a on the beam 315-a and a per-beam LBT procedure 320-b on the beam 315-b (e.g., simultaneously). In some cases, at time T1, the per-beam LBT procedure 320-a on the beam 315-a may be successful while the per-beam LBT procedure 320-b on the beam 315-b may be unsuccessful. In such cases, the UE 115-c may communicate on the channel during the COT 325 via the beam 315-a based on the per-beam LBT procedure 320-a being successful and the channel occupancy configuration enabling use of the COT 325 by the UE 115-c when only a subset of beams 315, such as the beam 315-a, have a successful per-beam LBT procedure 320, such as the per-beam LBT procedure 320-a. Additionally, the UE 115-c may abandon the per-beam LBT procedure 320-b on the beam 315-b (e.g., at time T1). That is, the UE 115-c may refrain from communicating on the channel during the COT 325 via the beam 315-b. In other words, the UE 115-c may occupy the beam 315-a in the COT 325 and refrain from occupying the beam 315-b in the COT 325.

Alternatively (e.g., not depicted in FIG. 3), the capability message 305 may indicate that the UE 115-c is not capable of supporting the per-beam LBT procedures 320. In such cases, the network entity 105-c may refrain from transmitting the control message 310.

While much of the present disclosure is described in the context of per-beam LBT procedures, this is not to be regarded as a limitation of the present disclosure. Indeed, it is contemplated herein that a capability message may indicate a capability of a UE to support per-beam channel access procedures, including per-beam LBT procedures. In this regard, other per-beam channel access procedures may be considered with regards to the techniques described herein.

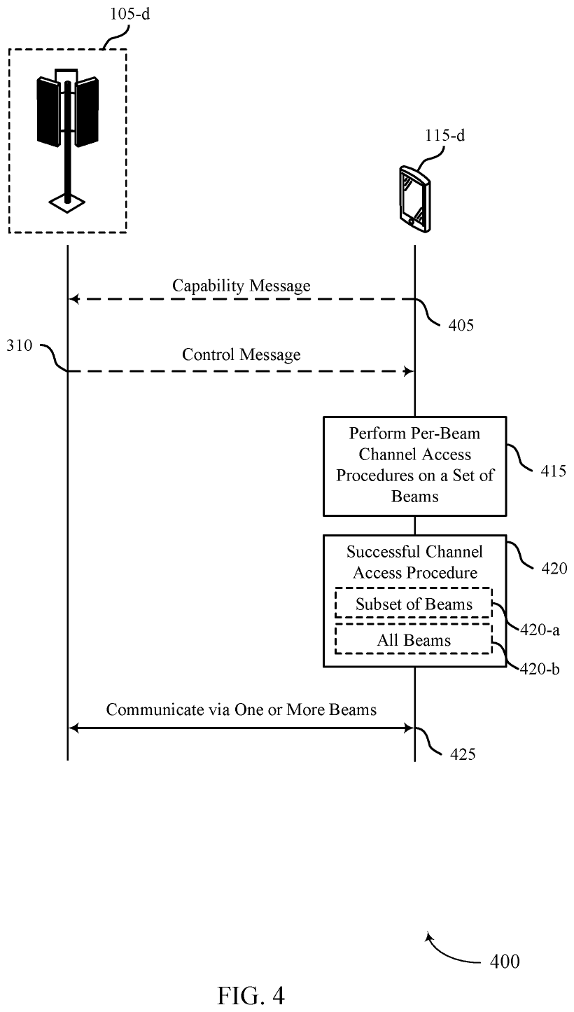

FIG. 4 illustrates an example of a process flow 400 in a system that supports signaling for channel access using multi-beam sensing in accordance with one or more aspects of the present disclosure. In some examples, the process flow 400 may implement aspects of the wireless communications system 100, the channel access procedures 200, and the channel access procedure 300. For example, the process flow may include one or more network entities 105 (e.g., a network entity 105-d) and one or more UEs 115 (e.g., a UE 115-d), which may be examples of the corresponding devices as described with reference to FIG. 1. In the example of FIG. 4, the network entities 105 may be examples of a CU 160, a DU 165, an RU 170, a base station 140, an IAB node 104, or one or more other network nodes as described with reference to FIG. 1. In some cases, the network entity 105-d may transmit, to the UE 115-d, a control message indicating a channel occupancy configuration associated with per-beam channel access procedures.

In some cases, at 405, the UE 115-d may transmit, to the entity 105-d, a capability message indicating a capability of the UE 115-d to support per-beam channel access procedures for communicating in one or more shared radio frequency spectrum bands. In some cases, the capability message may include an indication of a threshold quantity of simultaneous per-beam channel access procedures supported by the UE 115-d. For example, the indication may include a threshold quantity of simultaneous per-beam channel access procedures associated with a first type of channel access procedure, a threshold quantity of simultaneous per-beam channel access procedures associated with a second type of channel access procedure, a threshold quantity of simultaneous per-beam channel access procedures associated with a third type of channel access procedure, or any combination thereof.

In some cases, at 410, the network entity 105-d may transmit, to the UE 115-d, a control message indicating a channel occupancy configuration that is associated with the per-beam channel access procedures for communicating in the one or more shared radio frequency spectrum bands.

In some cases, the control message may include an indication of one or more timers associated with the per-beam channel access procedures. In some cases, the control message may be an RRC message, such that the UE 115-d may receive the RRC message indicating the channel configuration, the channel occupancy configuration including a UE-specific configuration for the UE 115-d. Alternatively, the control message may be a system information message (e.g., one or more SIBs), such that the UE 115-d may receive the system information message indicating the channel configuration, the channel occupancy configuration includes a cell-specific configuration for a cell provided by a network entity 105-d.

In some cases, the channel occupancy configuration may be based on a radio access technology used by one or more network entities 105 or wireless devices for communicating in the one or more shared radio frequency spectrum bands. That is, the network entity 105-d may identify a presence of one or more other network entities 105 or wireless devices communicating in the one or more shared radio frequency spectrum bands and may transmit the control message enabling or disabling use of a COT by the UE 115-d when only a subset of beams of a set of a set of beams have a successful per-beam channel access procedure.

In some cases, the channel occupancy configuration may be based on a traffic type, one or more other wireless devices communicating with the UE 115-d, a number of wireless devices in a same cell as the UE 115-d, or any combination thereof.

At 415, the UE 115-d may perform a per-beam channel access procedure for each beam of a set of beams. In some cases, the UE 115-d may perform the per-beam channel access procedure for each beam of the set of beams based on the one or more timers associated with the per-beam channel access procedure (e.g., indicated in the control message). In such cases, the UE 115-d may determine that the per-beam channel access procedures are successful for at least a subset of beams of the set of beams upon expiration of the one or more timers.

At 420, the channel access procedure performed by the UE 115-d may be successful, which may indicate that the UE 115-d may occupy a COT for communications on a channel (e.g., a channel of a shared radio frequency spectrum band). For example, at 420-a, the per-beam channel access procedures may be successful for only the subset of beams. In some cases, the channel access procedures may be successful for a threshold number of beams of the set of beams. In such cases, the channel occupancy configuration may enable use of the COT by the UE 115-d when the subset of beams have a successful per-beam channel access procedure. As such, the UE 115-d may communicate on the channel during the COT via the one or more beams from the set of beams based on the per-beam channel access procedures being successful for the subset of beams.

In other examples, at 420-b, the per-beam channel access procedures may be successful for all beams of the set of beams. In such cases, the channel occupancy configuration may have disabled use of the COT by the UE 115-d when a portion of the set of beams have a successful per-beam channel access procedure. Accordingly, because all of the beams had a successful channel access procedure, the UE 115-d may communicate on the channel during the COT via the one or more beams from the set of beams based on the per-beam channel access procedures being successful for every beam of the set of beams.

In either case, at 425, the UE 115-d may communicate, with the network entity 105-d, via one or more beams from the set of beams based on the channel occupancy configuration and the per-beam channel access procedures being successful for at least the subset of beams of the set of beams. In such cases, the one or more beams may include the subset of beams or the entire set of beams based on the channel occupancy configuration and how many beams on which the per-beam channel access procedures were successful.

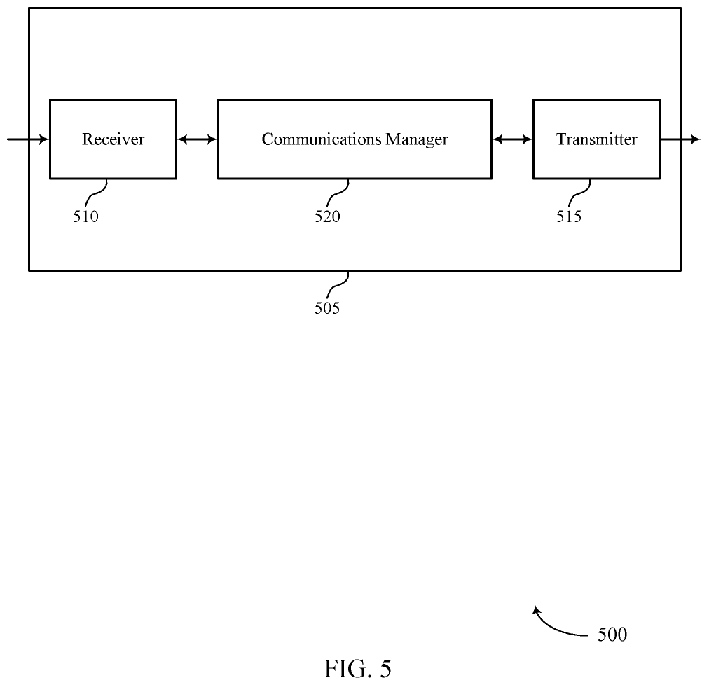

FIG. 5 shows a block diagram 500 of a device 505 that supports signaling for channel access using multi-beam sensing in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to signaling for channel access using multi-beam sensing). Information may be passed on to other components of the device 505. The receiver 510 may utilize a single antenna or a plurality antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling for channel access using multi-beam sensing). In some examples, the transmitter 515 may be co-located with a receiver 510 in a transceiver module. The transmitter 515 may utilize a single antenna or a plurality antennas.

The communications manager 520, the receiver 510, the transmitter 515, or various combinations thereof or various components thereof may be examples of means for performing various aspects of signaling for channel access using multi-beam sensing as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a control message indicating a channel occupancy configuration that is associated with per-beam channel access procedures for communicating in one or more shared radio frequency spectrum bands. The communications manager 520 may be configured as or otherwise support a means for performing a per-beam channel access procedure for each beam of a plurality beams. The communications manager 520 may be configured as or otherwise support a means for communicating via one or more beams from the plurality beams based at least in part on the channel occupancy configuration and the per-beam channel access procedures being successful for at least a subset of beams of the plurality beams.

Additionally, or alternatively, the communications manager 520 may support wireless communications at a UE in accordance with examples as disclosed herein. For example, the communications manager 520 may be configured as or otherwise support a means for transmitting a capability message indicating a capability of the UE to support per-beam channel access procedures for communicating in one or more shared radio frequency spectrum bands. The communications manager 520 may be configured as or otherwise support a means for performing a per-beam channel access procedure for one or more beams of a plurality beams in accordance with the capability. The communications manager 520 may be configured as or otherwise support a means for communicating via the one or more beams based at least in part on the per-beam channel access procedures being successful.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for signaling a capability of a UE to support per-beam channel access procedures for communicating in one or more shared radio frequency spectrum bands, signaling a channel occupancy configuration that is associated with the per-beam channel access procedures, or both, which may result in reduced processing, reduced power consumption, and more efficient utilization of communication resources, among other advantages.

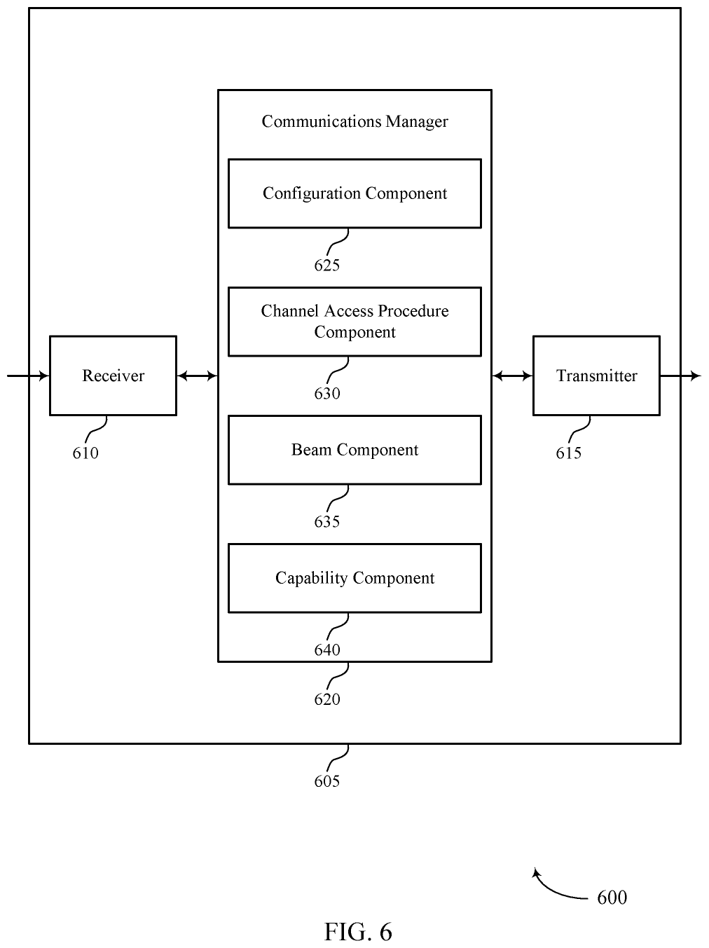

FIG. 6 shows a block diagram 600 of a device 605 that supports signaling for channel access using multi-beam sensing in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling for channel access using multi-beam sensing). Information may be passed on to other components of the device 605. The receiver 610 may utilize a single antenna or a plurality antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling for channel access using multi-beam sensing). In some examples, the transmitter 615 may be co-located with a receiver 610 in a transceiver module. The transmitter 615 may utilize a single antenna or a plurality antennas.

The device 605, or various components thereof, may be an example of means for performing various aspects of signaling for channel access using multi-beam sensing as described herein. For example, the communications manager 620 may include a configuration component 625, a channel access procedure component 630, a beam component 635, a capability component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The configuration component 625 may be configured as or otherwise support a means for receiving a control message indicating a channel occupancy configuration that is associated with per-beam channel access procedures for communicating in one or more shared radio frequency spectrum bands. The channel access procedure component 630 may be configured as or otherwise support a means for performing a per-beam channel access procedure for each beam of a plurality beams. The beam component 635 may be configured as or otherwise support a means for communicating via one or more beams from the plurality beams based at least in part on the channel occupancy configuration and the per-beam channel access procedures being successful for at least a subset of beams of the plurality beams.

Additionally, or alternatively, the communications manager 620 may support wireless communications at a UE in accordance with examples as disclosed herein. The capability component 640 may be configured as or otherwise support a means for transmitting a capability message indicating a capability of the UE to support per-beam channel access procedures for communicating in one or more shared radio frequency spectrum bands. The channel access procedure component 630 may be configured as or otherwise support a means for performing a per-beam channel access procedure for one or more beams of a plurality beams in accordance with the capability. The beam component 635 may be configured as or otherwise support a means for communicating via the one or more beams based at least in part on the per-beam channel access procedures being successful.

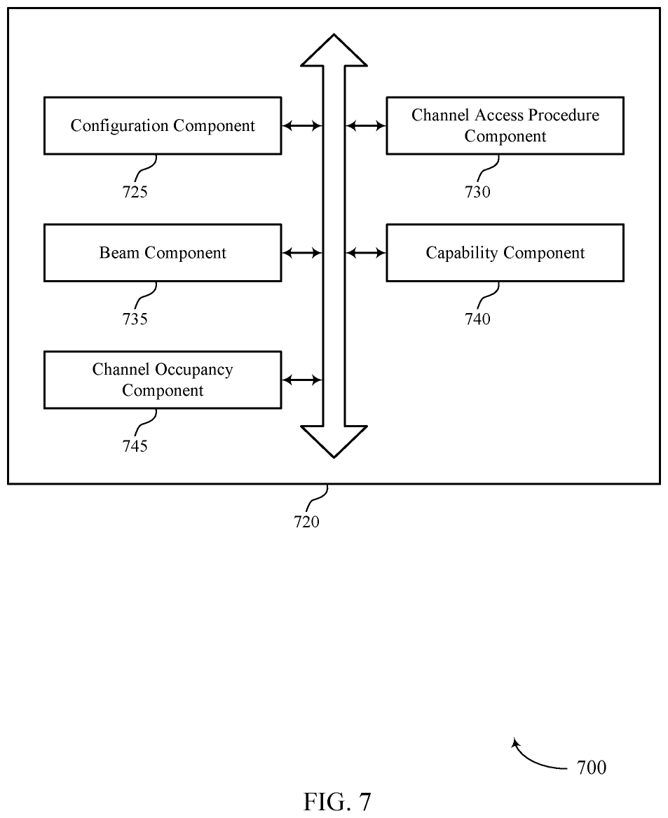

FIG. 7 shows a block diagram 700 of a communications manager 720 that supports signaling for channel access using multi-beam sensing in accordance with one or more aspects of the present disclosure. The communications manager 720 may be an example of aspects of a communications manager 520, a communications manager 620, or both, as described herein. The communications manager 720, or various components thereof, may be an example of means for performing various aspects of signaling for channel access using multi-beam sensing as described herein. For example, the communications manager 720 may include a configuration component 725, a channel access procedure component 730, a beam component 735, a capability component 740, a channel occupancy component 745, or any combination thereof. Each of these components may communicate, directly or indirectly, with one another (e.g., via one or more buses).

The communications manager 720 may support wireless communications at a UE in accordance with examples as disclosed herein. The configuration component 725 may be configured as or otherwise support a means for receiving a control message indicating a channel occupancy configuration that is associated with per-beam channel access procedures for communicating in one or more shared radio frequency spectrum bands. The channel access procedure component 730 may be configured as or otherwise support a means for performing a per-beam channel access procedure for each beam of a plurality beams. The beam component 735 may be configured as or otherwise support a means for communicating via one or more beams from the plurality beams based at least in part on the channel occupancy configuration and the per-beam channel access procedures being successful for at least a subset of beams of the plurality beams.

In some examples, to support communicating via the one or more beams, the channel occupancy component 745 may be configured as or otherwise support a means for communicating on a channel during a COT based at least in part on the per-beam channel access procedures being successful for the subset of beams, the one or more beams including the subset of beams.

In some examples, the channel occupancy configuration enables use of the COT by the UE when only the subset of beams have a successful per-beam channel access procedure.

In some examples, to support communicating via the one or more beams, the channel occupancy component 745 may be configured as or otherwise support a means for communicating on a channel during a COT based at least in part on the per-beam channel access procedures being successful for every beam of the plurality beams, the one or more beams including the plurality beams.

In some examples, the channel occupancy configuration disables use of the COT by the UE when only the subset of beams have a successful per-beam channel access procedure. In such cases, before the UE may transmit during the COT, the full set of beams may need to have a successful channel access procedure.

In some examples, to support performing the per-beam channel access procedure, the channel access procedure component 730 may be configured as or otherwise support a means for performing the per-beam channel access procedure for each beam of the plurality beams based at least in part on one or more timers associated with the per-beam channel access procedure, where the UE determines that the per-beam channel access procedures are successful upon expiration of the one or more timers.

In some examples, the control message includes an indication of the one or more timers associated with the per-beam channel access procedure.

In some examples, to support receiving the control message, the configuration component 725 may be configured as or otherwise support a means for receiving a radio resource control message indicating the channel occupancy configuration, the channel occupancy configuration including a UE-specific configuration for the UE.

In some examples, to support receiving the control message, the configuration component 725 may be configured as or otherwise support a means for receiving a system information message indicating the channel occupancy configuration, the channel occupancy configuration including a cell-specific configuration for a cell provided by a network entity.

In some examples, the channel occupancy configuration is based at least in part on a traffic type, one or more other wireless devices communicating with the UE, a number of wireless devices in a same cell as the UE, or any combination thereof.

In some examples, the channel occupancy configuration is based at least in part on a radio access technology used by one or more network entities or wireless devices for communicating in the one or more shared radio frequency spectrum bands.

In some examples, the capability component 740 may be configured as or otherwise support a means for transmitting a capability message indicating a capability of the UE to support the per-beam channel access procedure, where receiving the control message is based at least in part on the capability message.

Additionally, or alternatively, the communications manager 720 may support wireless communications at a UE in accordance with examples as disclosed herein. The capability component 740 may be configured as or otherwise support a means for transmitting a capability message indicating a capability of the UE to support per-beam channel access procedures for communicating in one or more shared radio frequency spectrum bands. In some examples, the channel access procedure component 730 may be configured as or otherwise support a means for performing a per-beam channel access procedure for one or more beams of a plurality beams in accordance with the capability. In some examples, the beam component 735 may be configured as or otherwise support a means for communicating via the one or more beams based at least in part on the per-beam channel access procedures being successful.

In some examples, to support transmitting the capability message, the capability component 740 may be configured as or otherwise support a means for transmitting, within the capability message, an indication of a threshold quantity of simultaneous per-beam channel access procedures supported by the UE.

In some examples, the indication includes a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

In some examples, the configuration component 725 may be configured as or otherwise support a means for receiving a control message indicating a channel occupancy configuration that is associated with the per-beam channel access procedures.

In some examples, the per-beam channel access procedures are successful for a subset of beams of the plurality beams. In some examples, the subset of beams are used for communicating during a COT based at least in part on the channel occupancy configuration enabling use of the COT by the UE when only the subset of beams have a successful per-beam channel access procedure.

In some examples, the per-beam channel access procedures are successful for every beam of the plurality beams. In some examples, the plurality beams are used for communicating during a COT based at least in part on the channel occupancy configuration disabling use of the COT by the UE when only a subset of beams from the plurality beams have a successful per-beam channel access procedure.

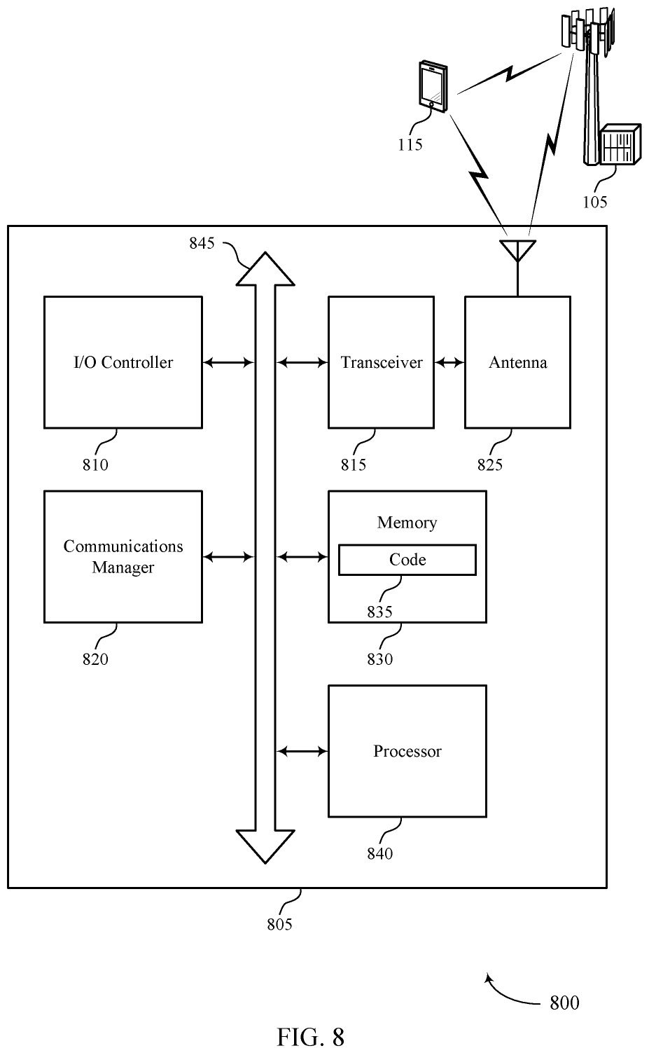

FIG. 8 shows a diagram of a system 800 including a device 805 that supports signaling for channel access using multi-beam sensing in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting signaling for channel access using multi-beam sensing). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a control message indicating a channel occupancy configuration that is associated with per-beam channel access procedures for communicating in one or more shared radio frequency spectrum bands. The communications manager 820 may be configured as or otherwise support a means for performing a per-beam channel access procedure for each beam of a plurality beams. The communications manager 820 may be configured as or otherwise support a means for communicating via one or more beams from the plurality beams based at least in part on the channel occupancy configuration and the per-beam channel access procedures being successful for at least a subset of beams of the plurality beams.

Additionally, or alternatively, the communications manager 820 may support wireless communications at a UE in accordance with examples as disclosed herein. For example, the communications manager 820 may be configured as or otherwise support a means for transmitting a capability message indicating a capability of the UE to support per-beam channel access procedures for communicating in one or more shared radio frequency spectrum bands. The communications manager 820 may be configured as or otherwise support a means for performing a per-beam channel access procedure for one or more beams of a plurality beams in accordance with the capability. The communications manager 820 may be configured as or otherwise support a means for communicating via the one or more beams based at least in part on the per-beam channel access procedures being successful.

By including or configuring the communications manager 820 in accordance with examples as described herein, the device 805 may support techniques for signaling a capability of a UE to support per-beam channel access procedures for communicating in one or more shared radio frequency spectrum bands, signaling a channel occupancy configuration that is associated with the per-beam channel access procedures, or both, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of signaling for channel access using multi-beam sensing as described herein, or the processor 840 and the memory 830 may be otherwise configured to perform or support such operations.

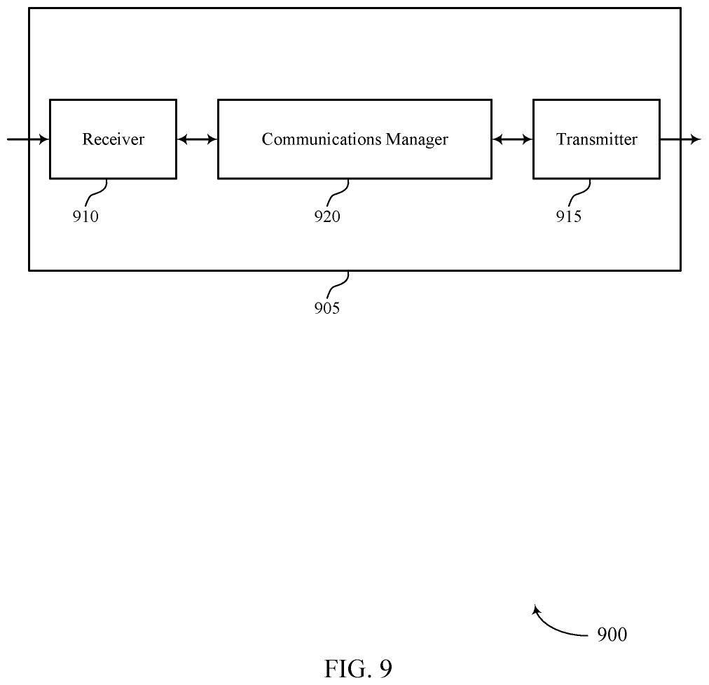

FIG. 9 shows a block diagram 900 of a device 905 that supports signaling for channel access using multi-beam sensing in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of signaling for channel access using multi-beam sensing as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a control message indicating a channel occupancy configuration that is associated with per-beam channel access procedures for communicating in one or more shared radio frequency spectrum bands. The communications manager 920 may be configured as or otherwise support a means for communicating with a UE via one or more beams from a plurality beams based at least in part on the channel occupancy configuration.

Additionally, or alternatively, the communications manager 920 may support wireless communications at a network entity in accordance with examples as disclosed herein. For example, the communications manager 920 may be configured as or otherwise support a means for receiving a capability message indicating a capability of a UE to support per-beam channel access procedures for communicating in one or more shared radio frequency spectrum bands. The communications manager 920 may be configured as or otherwise support a means for communicating with the UE via one or more beams from a plurality beams based at least in part on the capability.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for signaling a capability of a UE to support per-beam channel access procedures for communicating in one or more shared radio frequency spectrum bands, signaling a channel occupancy configuration that is associated with the per-beam channel access procedures, or both, which may result in reduced processing, reduced power consumption, and more efficient utilization of communication resources, among other advantages.

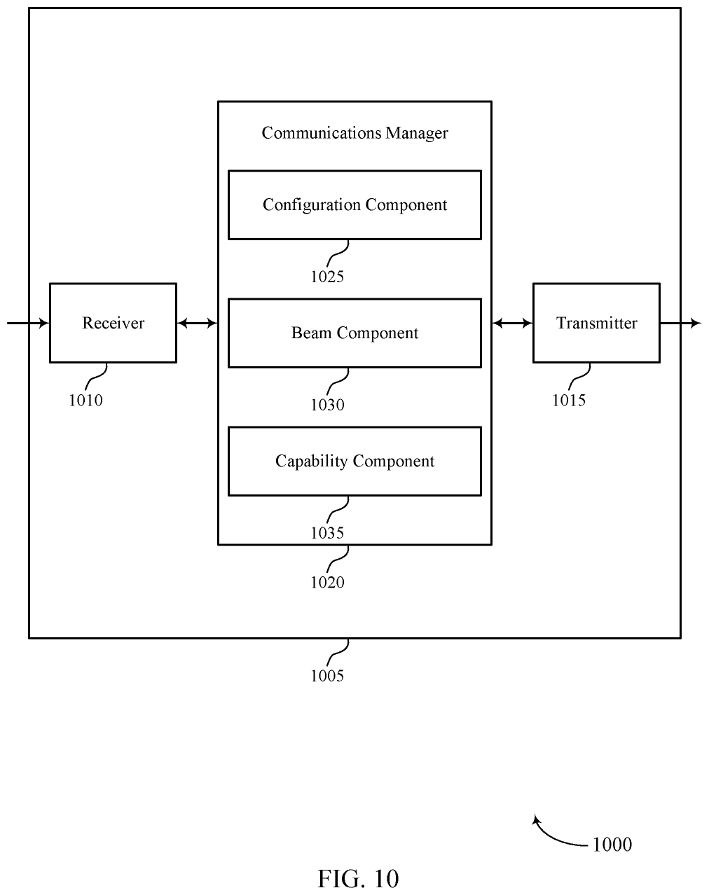

FIG. 10 shows a block diagram 1000 of a device 1005 that supports signaling for channel access using multi-beam sensing in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of signaling for channel access using multi-beam sensing as described herein. For example, the communications manager 1020 may include a configuration component 1025, a beam component 1030, a capability component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The configuration component 1025 may be configured as or otherwise support a means for transmitting a control message indicating a channel occupancy configuration that is associated with per-beam channel access procedures for communicating in one or more shared radio frequency spectrum bands. The beam component 1030 may be configured as or otherwise support a means for communicating with a UE via one or more beams from a plurality beams based at least in part on the channel occupancy configuration.

Additionally, or alternatively, the communications manager 1020 may support wireless communications at a network entity in accordance with examples as disclosed herein. The capability component 1035 may be configured as or otherwise support a means for receiving a capability message indicating a capability of a UE to support per-beam channel access procedures for communicating in one or more shared radio frequency spectrum bands. The beam component 1030 may be configured as or otherwise support a means for communicating with the UE via one or more beams from a plurality beams based at least in part on the capability.

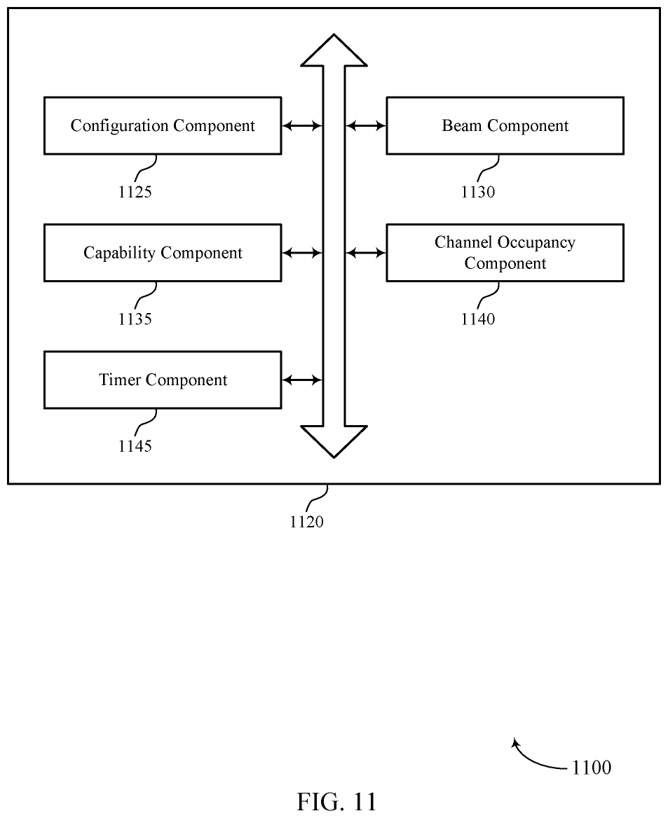

FIG. 11 shows a block diagram 1100 of a communications manager 1120 that supports signaling for channel access using multi-beam sensing in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of signaling for channel access using multi-beam sensing as described herein. For example, the communications manager 1120 may include a configuration component 1125, a beam component 1130, a capability component 1135, a channel occupancy component 1140, a timer component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The configuration component 1125 may be configured as or otherwise support a means for transmitting a control message indicating a channel occupancy configuration that is associated with per-beam channel access procedures for communicating in one or more shared radio frequency spectrum bands. The beam component 1130 may be configured as or otherwise support a means for communicating with a UE via one or more beams from a plurality beams based at least in part on the channel occupancy configuration.

In some examples, to support communicating via the one or more beams, the channel occupancy component 1140 may be configured as or otherwise support a means for communicating on a channel during a COT based at least in part on the channel occupancy configuration, the one or more beams including a subset of beams from the plurality beams.

In some examples, the channel occupancy configuration enables use of the COT by a UE when only the subset of beams have a successful per-beam channel access procedure.

In some examples, to support communicating via the one or more beams, the channel occupancy component 1140 may be configured as or otherwise support a means for communicating on a channel during a COT based at least in part on the channel occupancy configuration, the one or more beams including the plurality beams.

In some examples, the channel occupancy configuration disables use of the COT by a UE when only a subset of beams have a successful per-beam channel access procedure.

In some examples, to support transmitting the control message, the timer component 1145 may be configured as or otherwise support a means for transmitting an indication of one or more timers associated with the per-beam channel access procedure, where the control message includes the indication.

In some examples, to support transmitting the control message, the configuration component 1125 may be configured as or otherwise support a means for transmitting a radio resource control message indicating the channel occupancy configuration, the channel occupancy configuration including a UE-specific configuration for the UE.

In some examples, to support transmitting the control message, the configuration component 1125 may be configured as or otherwise support a means for transmitting a system information message indicating the channel occupancy configuration, the channel occupancy configuration including a cell-specific configuration for a cell provided by the network entity.

In some examples, the configuration component 1125 may be configured as or otherwise support a means for identifying a presence of one or more other network entities or wireless devices communicating in the one or more shared radio frequency spectrum bands, where the channel occupancy configuration is based at least in part on a radio access technology used by each of the one or more other network entities or wireless devices.

In some examples, the channel occupancy configuration is based at least in part on a traffic type, one or more other wireless devices communicating with a UE, a number of wireless devices in a same cell as the UE, or any combination thereof.

In some examples, the capability component 1135 may be configured as or otherwise support a means for receiving a capability message indicating a capability of a UE to support the per-beam channel access procedure, where receiving the control message is based at least in part on the capability message.

Additionally, or alternatively, the communications manager 1120 may support wireless communications at a network entity in accordance with examples as disclosed herein. The capability component 1135 may be configured as or otherwise support a means for receiving a capability message indicating a capability of a UE to support per-beam channel access procedures for communicating in one or more shared radio frequency spectrum bands. In some examples, the beam component 1130 may be configured as or otherwise support a means for communicating with the UE via one or more beams from a plurality beams based at least in part on the capability.

In some examples, to support receiving the capability message, the capability component 1135 may be configured as or otherwise support a means for receiving, within the capability message, an indication of a threshold quantity of simultaneous per-beam channel access procedures supported by the UE.

In some examples, the indication includes a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

In some examples, the configuration component 1125 may be configured as or otherwise support a means for transmitting a control message indicating a channel occupancy configuration that is associated with the per-beam channel access procedures.

In some examples, a subset of beams of the plurality beams are used for communicating during a COT based at least in part on the channel occupancy configuration enabling use of the COT by the UE when only the subset of beams have a successful per-beam channel access procedure.

In some examples, the plurality beams are used for communicating during a COT based at least in part on the channel occupancy configuration disabling use of the COT by the UE when only a subset of beams from the plurality beams have a successful per-beam channel access procedure.

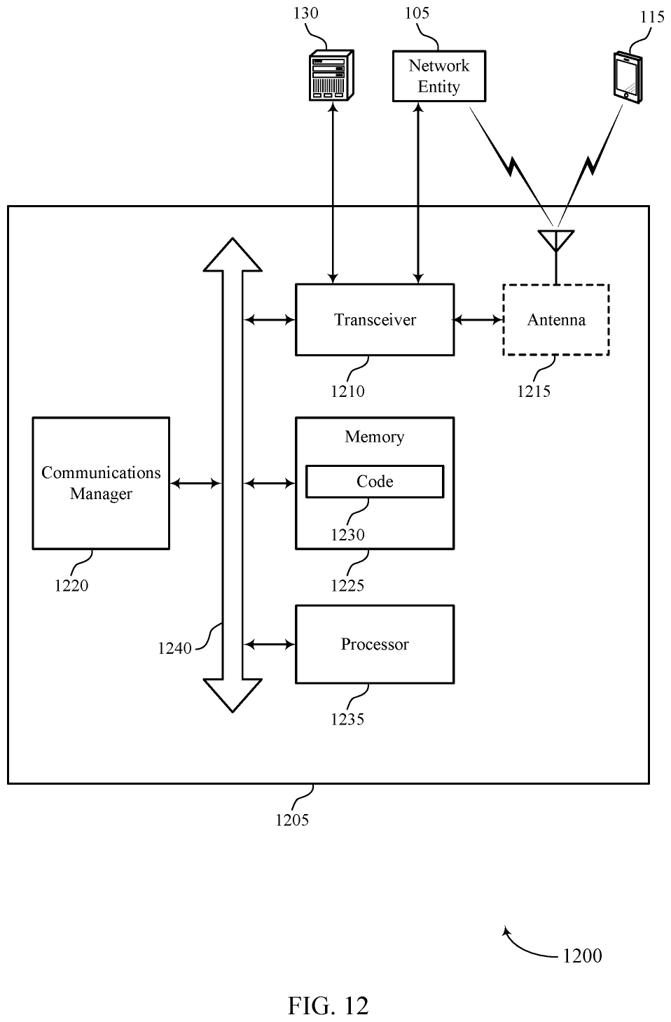

FIG. 12 shows a diagram of a system 1200 including a device 1205 that supports signaling for channel access using multi-beam sensing in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting signaling for channel access using multi-beam sensing). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a control message indicating a channel occupancy configuration that is associated with per-beam channel access procedures for communicating in one or more shared radio frequency spectrum bands. The communications manager 1220 may be configured as or otherwise support a means for communicating with a UE via one or more beams from a plurality beams based at least in part on the channel occupancy configuration.

Additionally, or alternatively, the communications manager 1220 may support wireless communications at a network entity in accordance with examples as disclosed herein. For example, the communications manager 1220 may be configured as or otherwise support a means for receiving a capability message indicating a capability of a UE to support per-beam channel access procedures for communicating in one or more shared radio frequency spectrum bands. The communications manager 1220 may be configured as or otherwise support a means for communicating with the UE via one or more beams from a plurality beams based at least in part on the capability.

By including or configuring the communications manager 1220 in accordance with examples as described herein, the device 1205 may support techniques for signaling a capability of a UE to support per-beam channel access procedures for communicating in one or more shared radio frequency spectrum bands, signaling a channel occupancy configuration that is associated with the per-beam channel access procedures, or both, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of signaling for channel access using multi-beam sensing as described herein, or the processor 1235 and the memory 1225 may be otherwise configured to perform or support such operations.

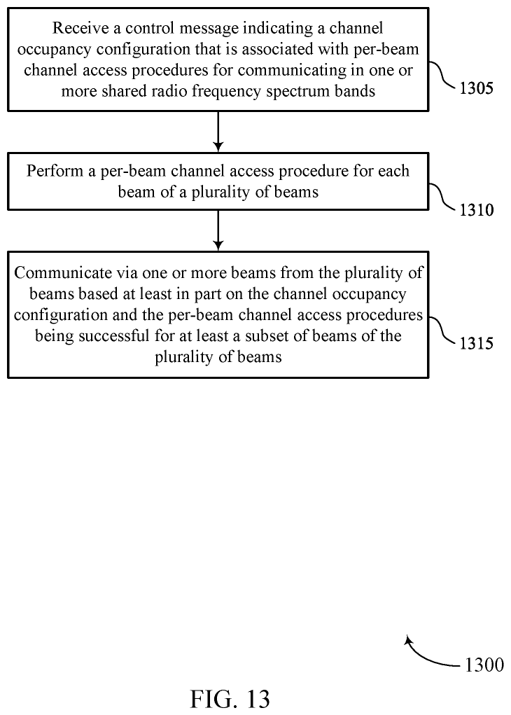

FIG. 13 shows a flowchart illustrating a method 1300 that supports signaling for channel access using multi-beam sensing in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating a channel occupancy configuration that is associated with per-beam channel access procedures for communicating in one or more shared radio frequency spectrum bands. The operations of 1305 may be performed in accordance with examples as disclosed herein. In some examples, aspects of the operations of 1305 may be performed by a configuration component 725 as described with reference to FIG. 7.

At 1310, the method may include performing a per-beam channel access procedure for each beam of a plurality beams. The operations of 1310 may be performed in accordance with examples as disclosed herein. In some examples, aspects of the operations of 1310 may be performed by a channel access procedure component 730 as described with reference to FIG. 7.

At 1315, the method may include communicating via one or more beams from the plurality beams based at least in part on the channel occupancy configuration and the per-beam channel access procedures being successful for at least a subset of beams of the plurality beams. The operations of 1315 may be performed in accordance with examples as disclosed herein. In some examples, aspects of the operations of 1315 may be performed by a beam component 735 as described with reference to FIG. 7.

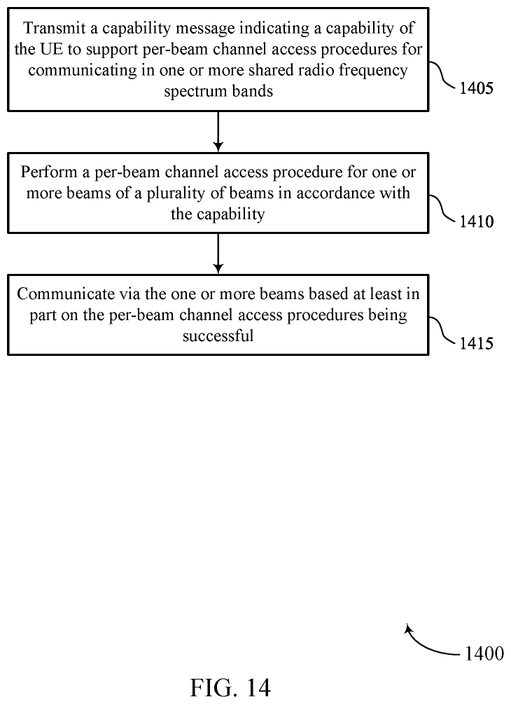

FIG. 14 shows a flowchart illustrating a method 1400 that supports signaling for channel access using multi-beam sensing in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a capability of the UE to support per-beam channel access procedures for communicating in one or more shared radio frequency spectrum bands. The operations of 1405 may be performed in accordance with examples as disclosed herein. In some examples, aspects of the operations of 1405 may be performed by a capability component 740 as described with reference to FIG. 7.

At 1410, the method may include performing a per-beam channel access procedure for one or more beams of a plurality beams in accordance with the capability. The operations of 1410 may be performed in accordance with examples as disclosed herein. In some examples, aspects of the operations of 1410 may be performed by a channel access procedure component 730 as described with reference to FIG. 7.

At 1415, the method may include communicating via the one or more beams based at least in part on the per-beam channel access procedures being successful. The operations of 1415 may be performed in accordance with examples as disclosed herein. In some examples, aspects of the operations of 1415 may be performed by a beam component 735 as described with reference to FIG. 7.

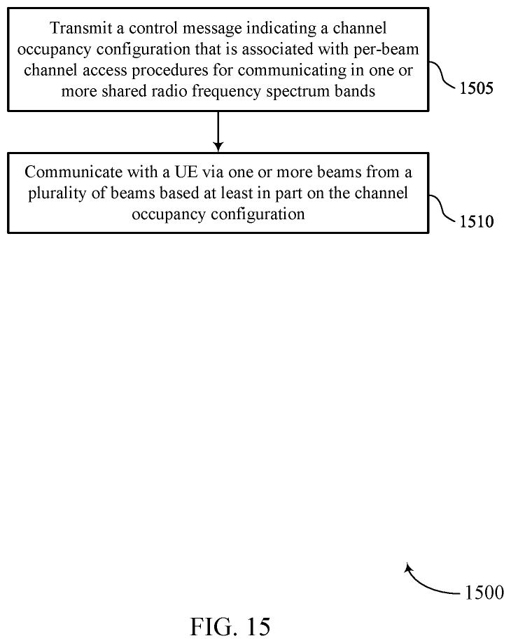

FIG. 15 shows a flowchart illustrating a method 1500 that supports signaling for channel access using multi-beam sensing in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a control message indicating a channel occupancy configuration that is associated with per-beam channel access procedures for communicating in one or more shared radio frequency spectrum bands. The operations of 1505 may be performed in accordance with examples as disclosed herein. In some examples, aspects of the operations of 1505 may be performed by a configuration component 1125 as described with reference to FIG. 11.

At 1510, the method may include communicating with a UE via one or more beams from a plurality beams based at least in part on the channel occupancy configuration. The operations of 1510 may be performed in accordance with examples as disclosed herein. In some examples, aspects of the operations of 1510 may be performed by a beam component 1130 as described with reference to FIG. 11.

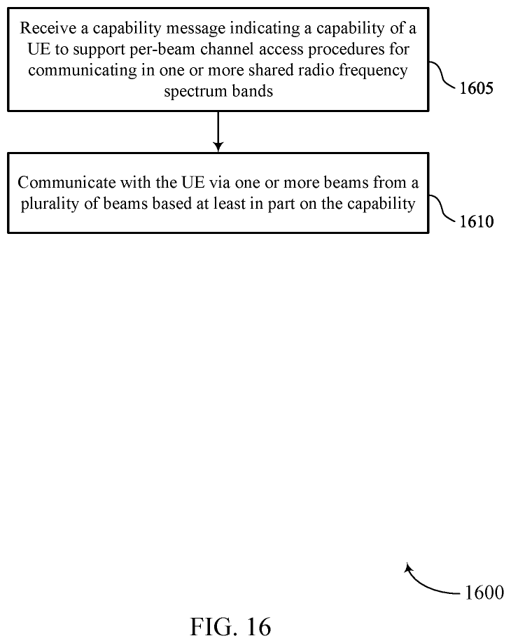

FIG. 16 shows a flowchart illustrating a method 1600 that supports signaling for channel access using multi-beam sensing in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message indicating a capability of a UE to support per-beam channel access procedures for communicating in one or more shared radio frequency spectrum bands. The operations of 1605 may be performed in accordance with examples as disclosed herein. In some examples, aspects of the operations of 1605 may be performed by a capability component 1135 as described with reference to FIG. 11.

At 1610, the method may include communicating with the UE via one or more beams from a plurality beams based at least in part on the capability. The operations of 1610 may be performed in accordance with examples as disclosed herein. In some examples, aspects of the operations of 1610 may be performed by a beam component 1130 as described with reference to FIG. 11.

The following provides an overview of aspects of the present disclosure:

Aspect 1: A method for wireless communications at a UE, comprising: receiving a control message indicating a channel occupancy configuration that is associated with per-beam channel access procedures for communicating in one or more shared radio frequency spectrum bands; performing a per-beam channel access procedure for each beam of a plurality of beams; and communicating via one or more beams from the plurality of beams based at least in part on the channel occupancy configuration and the per-beam channel access procedures being successful for at least a subset of beams of the plurality of beams.

Aspect 2: The method of aspect 1, wherein communicating via the one or more beams comprises: communicating on a channel during a channel occupancy time based at least in part on the per-beam channel access procedures being successful for the subset of beams, the one or more beams comprising the subset of beams.

Aspect 3: The method of aspect 2, wherein the channel occupancy configuration enables use of the channel occupancy time by the UE when only the subset of beams have a successful per-beam channel access procedure.

Aspect 4: The method of aspect 1, wherein communicating via the one or more beams comprises: communicating on a channel during a channel occupancy time based at least in part on the per-beam channel access procedures being successful for every beam of the plurality of beams, the one or more beams comprising the plurality of beams.

Aspect 5: The method of aspect 4, wherein the channel occupancy configuration disables use of the channel occupancy time by the UE when only the subset of beams have a successful per-beam channel access procedure.

Aspect 6: The method of any of aspects 1 through 5, wherein performing the per-beam channel access procedure comprises: performing the per-beam channel access procedure for each beam of the plurality of beams based at least in part on one or more timers associated with the per-beam channel access procedure, wherein the UE determines that the per-beam channel access procedures are successful upon expiration of the one or more timers.

Aspect 7: The method of aspect 6, wherein the control message comprises an indication of the one or more timers associated with the per-beam channel access procedure.

Aspect 8: The method of any of aspects 1 through 7, wherein receiving the control message comprises: receiving a radio resource control message indicating the channel occupancy configuration, the channel occupancy configuration comprising a UE-specific configuration for the UE.

Aspect 9: The method of any of aspects 1 through 8, wherein receiving the control message comprises: receiving a system information message indicating the channel occupancy configuration, the channel occupancy configuration comprising a cell-specific configuration for a cell provided by a network entity.

Aspect 10: The method of any of aspects 1 through 9, wherein the channel occupancy configuration is based at least in part on a traffic type, one or more other wireless devices communicating with the UE, a number of wireless devices in a same cell as the UE, or any combination thereof.

Aspect 11: The method of any of aspects 1 through 10, wherein the channel occupancy configuration is based at least in part on a RAT used by one or more network entities or wireless devices for communicating in the one or more shared radio frequency spectrum bands.

Aspect 12: The method of any of aspects 1 through 11, further comprising: transmitting a capability message indicating a capability of the UE to support the per-beam channel access procedure, wherein receiving the control message is based at least in part on the capability message.

Aspect 13: A method for wireless communications at a UE, comprising: transmitting a capability message indicating a capability of the UE to support per-beam channel access procedures for communicating in one or more shared radio frequency spectrum bands; performing a per-beam channel access procedure for one or more beams of a plurality of beams in accordance with the capability; and communicating via the one or more beams based at least in part on the per-beam channel access procedures being successful.

Aspect 14: The method of aspect 13, wherein transmitting the capability message comprises: transmitting, within the capability message, an indication of a threshold quantity of simultaneous per-beam channel access procedures supported by the UE.

Aspect 15: The method of aspect 14, wherein the indication comprises a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

Aspect 16: The method of any of aspects 13 through 15, further comprising: receiving a control message indicating a channel occupancy configuration that is associated with the per-beam channel access procedures.

Aspect 17: The method of aspect 16, wherein the per-beam channel access procedures are successful for a subset of beams of the plurality of beams, and the subset of beams are used for communicating during a channel occupancy time based at least in part on the channel occupancy configuration enabling use of the channel occupancy time by the UE when only the subset of beams have a successful per-beam channel access procedure.

Aspect 18: The method of any of aspects 16 through 17, wherein the per-beam channel access procedures are successful for every beam of the plurality of beams, and the plurality of beams are used for communicating during a channel occupancy time based at least in part on the channel occupancy configuration disabling use of the channel occupancy time by the UE when only a subset of beams from the plurality of beams have a successful per-beam channel access procedure.

Aspect 19: A method for wireless communications at a network entity, comprising: transmitting a control message indicating a channel occupancy configuration that is associated with per-beam channel access procedures for communicating in one or more shared radio frequency spectrum bands; and communicating with a UE via one or more beams from a plurality of beams based at least in part on the channel occupancy configuration.

Aspect 20: The method of aspect 19, wherein communicating via the one or more beams comprises: communicating on a channel during a channel occupancy time based at least in part on the channel occupancy configuration, the one or more beams comprising a subset of beams from the plurality of beams.

Aspect 21: The method of aspect 20, wherein the channel occupancy configuration enables use of the channel occupancy time by a UE when only the subset of beams have a successful per-beam channel access procedure.

Aspect 22: The method of aspect 19, wherein communicating via the one or more beams comprises: communicating on a channel during a channel occupancy time based at least in part on the channel occupancy configuration, the one or more beams comprising the plurality of beams.

Aspect 23: The method of aspect 22, wherein the channel occupancy configuration disables use of the channel occupancy time by a UE when only a subset of beams have a successful per-beam channel access procedure.

Aspect 24: The method of any of aspects 19 through 23, wherein transmitting the control message comprises: transmitting an indication of one or more timers associated with the per-beam channel access procedure, wherein the control message comprises the indication.

Aspect 25: The method of any of aspects 19 through 24, wherein transmitting the control message comprises: transmitting a radio resource control message indicating the channel occupancy configuration, the channel occupancy configuration comprising a UE-specific configuration for the UE.

Aspect 26: The method of any of aspects 19 through 25, wherein transmitting the control message comprises: transmitting a system information message indicating the channel occupancy configuration, the channel occupancy configuration comprising a cell-specific configuration for a cell provided by the network entity.

Aspect 27: The method of any of aspects 19 through 26, further comprising: identifying a presence of one or more other network entities or wireless devices communicating in the one or more shared radio frequency spectrum bands, wherein the channel occupancy configuration is based at least in part on a RAT used by each of the one or more other network entities or wireless devices.

Aspect 28: The method of any of aspects 19 through 27, wherein the channel occupancy configuration is based at least in part on a traffic type, one or more other wireless devices communicating with a UE, a number of wireless devices in a same cell as the UE, or any combination thereof.

Aspect 29: The method of any of aspects 19 through 28, further comprising: receiving a capability message indicating a capability of a UE to support the per-beam channel access procedure, wherein receiving the control message is based at least in part on the capability message.

Aspect 30: A method for wireless communications at a network entity, comprising: receiving a capability message indicating a capability of a UE to support per-beam channel access procedures for communicating in one or more shared radio frequency spectrum bands; and communicating with the UE via one or more beams from a plurality of beams based at least in part on the capability.

Aspect 31: The method of aspect 30, wherein receiving the capability message comprises: receiving, within the capability message, an indication of a threshold quantity of simultaneous per-beam channel access procedures supported by the UE.

Aspect 32: The method of aspect 31, wherein the indication comprises a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

Aspect 33: The method of any of aspects 30 through 32, further comprising: transmitting a control message indicating a channel occupancy configuration that is associated with the per-beam channel access procedures.

Aspect 34: The method of aspect 33, wherein a subset of beams of the plurality of beams are used for communicating during a channel occupancy time based at least in part on the channel occupancy configuration enabling use of the channel occupancy time by the UE when only the subset of beams have a successful per-beam channel access procedure.

Aspect 35: The method of any of aspects 33 through 34, wherein the plurality of beams are used for communicating during a channel occupancy time based at least in part on the channel occupancy configuration disabling use of the channel occupancy time by the UE when only a subset of beams from the plurality of beams have a successful per-beam channel access procedure.

Aspect 36: An apparatus for wireless communications at a UE, comprising a processor; memory coupled with the processor; and instructions stored in the memory and executable by the processor to cause the apparatus to perform a method of any of aspects 1 through 12.

Aspect 37: An apparatus for wireless communications at a UE, comprising at least one means for performing a method of any of aspects 1 through 12.

Aspect 38: A non-transitory computer-readable medium storing code for wireless communications at a UE, the code comprising instructions executable by a processor to perform a method of any of aspects 1 through 12.

Aspect 39: An apparatus for wireless communications at a UE, comprising a processor; memory coupled with the processor; and instructions stored in the memory and executable by the processor to cause the apparatus to perform a method of any of aspects 13 through 18.

Aspect 40: An apparatus for wireless communications at a UE, comprising at least one means for performing a method of any of aspects 13 through 18.

Aspect 41: A non-transitory computer-readable medium storing code for wireless communications at a UE, the code comprising instructions executable by a processor to perform a method of any of aspects 13 through 18.

Aspect 42: An apparatus for wireless communications at a network entity, comprising a processor; memory coupled with the processor; and instructions stored in the memory and executable by the processor to cause the apparatus to perform a method of any of aspects 19 through 29.

Aspect 43: An apparatus for wireless communications at a network entity, comprising at least one means for performing a method of any of aspects 19 through 29.

Aspect 44: A non-transitory computer-readable medium storing code for wireless communications at a network entity, the code comprising instructions executable by a processor to perform a method of any of aspects 19 through 29.

Aspect 45: An apparatus for wireless communications at a network entity, comprising a processor; memory coupled with the processor; and instructions stored in the memory and executable by the processor to cause the apparatus to perform a method of any of aspects 30 through 35.

Aspect 46: An apparatus for wireless communications at a network entity, comprising at least one means for performing a method of any of aspects 30 through 35.

Aspect 47: A non-transitory computer-readable medium storing code for wireless communications at a network entity, the code comprising instructions executable by a processor to perform a method of any of aspects 30 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
a memory coupled with the processor, wherein the memory comprises instructions executable by the processor to cause the apparatus to:
receive a control message indicating a channel occupancy configuration that is associated with per-beam channel access procedures for communicating in one or more shared radio frequency spectrum bands;
perform a per-beam channel access procedure for each beam of a plurality of beams; and
communicate via one or more beams from the plurality of beams based at least in part on the channel occupancy configuration and the per-beam channel access procedures being successful for at least a subset of beams of the plurality of beams.

2. The apparatus of claim 1, wherein the instructions to communicate via the one or more beams are executable by the processor to cause the apparatus to:
communicate on a channel during a channel occupancy time based at least in part on the per-beam channel access procedures being successful for the subset of beams, the one or more beams comprising the subset of beams.

3. The apparatus of claim 2, wherein the channel occupancy configuration enables use of the channel occupancy time by the UE when only the subset of beams have a successful per-beam channel access procedure.

4. The apparatus of claim 1, wherein the instructions to communicate via the one or more beams are executable by the processor to cause the apparatus to:
communicate on a channel during a channel occupancy time based at least in part on the per-beam channel access procedures being successful for every beam of the plurality of beams, the one or more beams comprising the plurality of beams.

5. The apparatus of claim 4, wherein the channel occupancy configuration disables use of the channel occupancy time by the UE when only the subset of beams have a successful per-beam channel access procedure.

6. The apparatus of claim 1, wherein the instructions to perform the per-beam channel access procedure are executable by the processor to cause the apparatus to:
perform the per-beam channel access procedure for each beam of the plurality of beams based at least in part on one or more timers associated with the per-beam channel access procedure, wherein the UE determines that the per-beam channel access procedures are successful upon expiration of the one or more timers.

7. The apparatus of claim 6, wherein the control message comprises an indication of the one or more timers associated with the per-beam channel access procedure.

8. The apparatus of claim 1, wherein the instructions to receive the control message are executable by the processor to cause the apparatus to:
receive a radio resource control message indicating the channel occupancy configuration, the channel occupancy configuration comprising a UE-specific configuration for the UE.

9. The apparatus of claim 1, wherein the instructions to receive the control message are executable by the processor to cause the apparatus to:
receive a system information message indicating the channel occupancy configuration, the channel occupancy configuration comprising a cell-specific configuration for a cell provided by a network entity.

10. The apparatus of claim 1, wherein the channel occupancy configuration is based at least in part on a traffic type, one or more other wireless devices communicating with the UE, a number of wireless devices in a same cell as the UE, a radio access technology used by one or more network entities or wireless devices for communicating in the one or more shared radio frequency spectrum bands, or any combination thereof.

11. The apparatus of claim 1, wherein the instructions are further executable by the processor to cause the apparatus to:
transmit a capability message indicating a capability of the UE to support the per-beam channel access procedure, wherein receiving the control message is based at least in part on the capability message.

12. An apparatus for wireless communications at a user equipment (UE), comprising:
a processor; and
a memory coupled with the processor, wherein the memory comprises instructions executable by the processor to cause the apparatus to:
transmit a capability message indicating a capability of the UE to support per-beam channel access procedures for communicating in one or more shared radio frequency spectrum bands;
perform a per-beam channel access procedure for one or more beams of a plurality of beams in accordance with the capability; and
communicate via the one or more beams based at least in part on the per-beam channel access procedures being successful.

13. The apparatus of claim 12, wherein the instructions to transmit the capability message are executable by the processor to cause the apparatus to:
transmit, within the capability message, an indication of a threshold quantity of simultaneous per-beam channel access procedures supported by the UE.

14. The apparatus of claim 13, wherein the indication comprises a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

15. The apparatus of claim 12, wherein the instructions are further executable by the processor to cause the apparatus to:
receive a control message indicating a channel occupancy configuration that is associated with the per-beam channel access procedures.

16. An apparatus for wireless communications at a network entity, comprising:
a processor; and
a memory coupled with the processor, wherein the memory comprises instructions executable by the processor to cause the apparatus to:
transmit a control message indicating a channel occupancy configuration that is associated with per-beam channel access procedures for communicating in one or more shared radio frequency spectrum bands; and
communicate with a user equipment (UE) via one or more beams from a plurality of beams based at least in part on the channel occupancy configuration.

17. The apparatus of claim 16, wherein the instructions to communicate via the one or more beams are executable by the processor to cause the apparatus to:
communicate on a channel during a channel occupancy time based at least in part on the channel occupancy configuration, the one or more beams comprising a subset of beams from the plurality of beams.

18. The apparatus of claim 17, wherein the channel occupancy configuration enables use of the channel occupancy time by a user equipment (UE) when only the subset of beams have a successful per-beam channel access procedure.

19. The apparatus of claim 16, wherein the instructions to communicate via the one or more beams are executable by the processor to cause the apparatus to:
communicate on a channel during a channel occupancy time based at least in part on the channel occupancy configuration, the one or more beams comprising the plurality of beams.

20. The apparatus of claim 19, wherein the channel occupancy configuration disables use of the channel occupancy time by a UE when only a subset of beams have a successful per-beam channel access procedure.

21. The apparatus of claim 16, wherein the instructions to transmit the control message are executable by the processor to cause the apparatus to:
transmit an indication of one or more timers associated with the per-beam channel access procedures, wherein the control message comprises the indication.

22. The apparatus of claim 16, wherein the instructions to transmit the control message are executable by the processor to cause the apparatus to:
transmit a radio resource control message indicating the channel occupancy configuration, the channel occupancy configuration comprising a UE-specific configuration for the UE.

23. The apparatus of claim 16, wherein the instructions to transmit the control message are executable by the processor to cause the apparatus to:
transmit a system information message indicating the channel occupancy configuration, the channel occupancy configuration comprising a cell-specific configuration for a cell provided by the network entity.

24. The apparatus of claim 16, wherein the instructions are further executable by the processor to cause the apparatus to:
identifying a presence of one or more other network entities or wireless devices communicating in the one or more shared radio frequency spectrum bands, wherein the channel occupancy configuration is based at least in part on a radio access technology used by each of the one or more other network entities or wireless devices.

25. The apparatus of claim 16, wherein the instructions are further executable by the processor to cause the apparatus to:
receive a capability message indicating a capability of a UE to support the per-beam channel access procedures, wherein receiving the control message is based at least in part on the capability message.

26. An apparatus for wireless communications at a network entity, comprising:
a processor; and
a memory coupled with the processor, wherein the memory comprises instructions executable by the processor to cause the apparatus to:
receive a capability message indicating a capability of a user equipment (UE) to support per-beam channel access procedures for communicating in one or more shared radio frequency spectrum bands; and
communicate with the UE via one or more beams from a plurality of beams based at least in part on the capability.

27. The apparatus of claim 26, wherein the instructions to receive the capability message are executable by the processor to cause the apparatus to:
receive, within the capability message, an indication of a threshold quantity of simultaneous per-beam channel access procedures supported by the UE.

28. The apparatus of claim 27, wherein the indication comprises a first threshold quantity of simultaneous per-beam channel access procedures associated with a first type of channel access procedure, a second threshold quantity of simultaneous per-beam channel access procedures associated with a second type of channel access procedure, a third threshold quantity of simultaneous per-beam channel access procedures associated with a third type of channel access procedure, or any combination thereof.

29. The apparatus of claim 26, wherein the instructions are further executable by the processor to cause the apparatus to:
transmit a control message indicating a channel occupancy configuration that is associated with the per-beam channel access procedures.

30. The apparatus of claim 29, wherein a subset of beams of the plurality of beams are used for communicating during a channel occupancy time based at least in part on the channel occupancy configuration enabling use of the channel occupancy time by the UE when only the subset of beams have a successful per-beam channel access procedure.
